(19) United States
(12) Patent Application Publication
(10) Pub. No.: US 2020/0158628 A1
(43) Pub. Date: May 21, 2020

(54) MULTIPLEXED ASSAY SYSTEMS AND METHODS

(71) Applicant: Bioelectronica Corporation, Reno, NV (US)

(72) Inventors: Roger CHEN, Saratoga, CA (US); Jonathan F. HULL, Reno, NV (US)

(21) Appl. No.: 16/660,377

(22) Filed: Oct. 22, 2019

Related U.S. Application Data
(60) Provisional application No. 62/800,389, filed on Feb. 1, 2019.
(60) Provisional application No. 62/748,972, filed on Oct. 22, 2018.

(51) Int. Cl. G01N 21/17; G01N 21/88; G01N 21/64

(52) U.S. Cl. CPC G01N 21/17; G01N 21/8806; G01N 2021/6439; G01N 2021/1772; G01N 2021/8829; G01N 21/6428

(57) ABSTRACT

A system for processing a sample includes a chamber for receiving a sample, at least one light source, and an imager array configured to generate a sample image of the sample in the chamber. The system can be used to process a sample in a multiplexed manner. For example, one variation of a method for processing a sample includes identifying one or more features of interest in the sample based at least in part on the forms and/or darkness shift of one or more marker particles depicted in the sample image. Another variation of a method includes illuminating the sample with light having a wavelength outside a wavelength detection window of the imager array, to thereby induce at least a portion of the sample to fluoresce light within the wavelength detection window.

### CROSS-REFERENCE TO RELATED APPLICATIONS

This application claims priority to U.S. Provisional Application Ser. No. 62/800,389 filed Feb. 1, 2019, and U.S. Provisional Application Ser. No. 62/748,972 filed Oct. 22, 2018, each of which is hereby incorporated herein by reference in its entirety.

### TECHNICAL FIELD

This invention relates generally to the field of assays for processing sample entities.

### BACKGROUND

Devices to conduct assays are commonly used for the purposes of biochemistry research, medical diagnostics, and other applications to detect and/or measure one or more components of a sample. A digital assay is one kind of assay that partitions a biological sample into multiple smaller containers such that each container contains a discrete number of biological entities. For example, a digital assay may be used to analyze microfluidic droplets including single cells or other entities, such as for quantifying nucleic acids, proteins, or other biological content.

Current microfluidic systems have a number of drawbacks. For example, conventional microfluidic digital assays require that droplets be monodisperse and of the same type (e.g., exclusively DNA) during an experiment, in order to, for example, accurately correlate measurements to analyte concentration and compare such measurements across different droplets. These devices require droplets to be pre-sorted to ensure that they are of suitably uniform size, which is time-consuming and reduces efficiency in processing droplets. Additionally, these devices include a linear, single-track microfluidic channel within which droplets travel in series for processing, which further limits the efficiency for analysis of the droplets. Accordingly, there is a need for new and improved digital assay systems and methods for processing samples.

### SUMMARY

Generally, in some variations, a method for processing a sample may include receiving a sample in a chamber, the sample comprising one or more marker particles each specific to an analyte, illuminating the same in the chamber with at least one light source, generating a sample image (e.g., shadow image) of the sample with an imager array, identifying one or more analytes in the sample based at least in part on a darkness shift of the one or more marker particles depicted in the sample image. In some variations, the method may include inducing the darkness shift through one or more enzyme-linked assay techniques.

The marker particles may include a first marker particle having a first form and a second marker particle having a second form different from the first form. For example, the first form may have a different size, a different shape, and/or a different material than the second form. In some variations, the first marker particle may be specific to a first analyte, and the second marker particle may be specific to a second analyte. The first marker particle may undergo a darkness shift in the presence of the first analyte, and/or the second marker particle may undergo a darkness shift in the presence of the second analyte. Accordingly, by identifying a darkened object in a shadow image as the first marker particle or the second marker particle, presence of the first analyte or the second analyte may be determined, respectively. Furthermore, when multiple darkened objects in a shadow image have been identified, distinguishing between the presence of the first analyte and the second analyte in the sample may be performed by determining whether an imaged object depicted in the sample image is the first marker particle or the second marker particle (e.g., based on the respective form of the marker particles).

Generally, a method for processing a sample includes receiving a sample in a chamber, where the sample includes one or more marker particles each specific to an analyte, illuminating the sample in the chamber with at least one light source, generating a sample image of the sample with an imager array, and identifying one or more analytes in the sample based at least in part on the sizes (e.g., diameter) of one or more particles depicted in the sample image. In some variations, the sample image may be a shadow image of the sample. For example, the imager array may be located opposite the light source. In some variations, the method may be used to process a sample including at least one flattened sample entity such as a POD (e.g., polydisperse PODS), as described in further detail herein.

In some variations, the sample may include a first marker having a first size and a second marker having second size different from the first size. The first marker may be specific to a first analyte or other feature of interest (e.g., cell) and the second marker may be specific to a second analyte or other feature of interest (e.g., cell). Accordingly, in some variations, the method can include distinguishing between the first analyte and the second analyte in the sample by determining whether an imaged object depicted in the sample image is the first marker or the second marker (e.g., based on size and/or shape). This determination may be accomplished generally, for example, by measuring the size of the imaged object and comparing the measured object size to the first size of the first marker and/or the second size of the second marker.

Markers of different sizes can additionally or alternatively form distinct types of marker constructs. For example, in some variations, the sample may include a marker construct including the first marker (of a first size) combined with the second marker (of a second size different from the first size), where the first marker and/or the second marker is specific to the first (or other) analyte or other feature of interest (e.g., cell). Accordingly, in some variations, the method can include determining whether an imaged object depicted in the sample image includes the first marker and the second marker.

Similarly, the sample can include a plurality of first markers of the first size configured to signify the presence of the first analyte (e.g., by agglutination, precipitation, etc.), and/or a plurality of second markers of the second size configured to signify the presence of a second analyte, where the plurality of first markers is separate from the plurality of second markers. In some variations, the sample can further include a first marker construct comprising at least one first marker of the first size combined with at least one second marker of the second size in a first pattern, wherein the first marker construct is specific to a third analyte or other feature of interest. Accordingly, in some variations, the method can include identifying the first analyte in the sample by identifying a first marker depicted in the sample image, identifying the second analyte in the sample by identifying a second marker depicted in the sample image, and identifying the third analyte in the sample by identifying the first marker construct depicted in the sample image. Furthermore, in some variations, the sample may include a second marker construct including at least one first marker of the first size combined with at least one second marker of the second size in a second pattern, wherein the second pattern is different from the first pattern. The second marker construct may be specific to a fourth analyte. Other suitable combinations and permutations of different markers of different sizes can be bound to form different marker constructs that are specific to a respective analyte, and can thus be identified in order to identify the respective analyte(s).

Generally, a method for preparing one or more samples for processing can include combining one or more samples with marker particles, where the one or more samples include a first analyte, a second analyte, and a third analyte, The marker particles may include a plurality of first markers each having a first size, a plurality of second markers each having a second size different from the first size, and a plurality of marker constructs including multiple marker particles (e.g., including at least one first marker combined with at least one second marker). Each of the plurality of first markers may be specific to the first analyte, each of the plurality of second markers may be specific to the second analyte, and each of the plurality of marker constructs may be specific to the third analyte. In some variations, the sample may be further prepared by dividing the combined one or more samples into PODS (e.g., polydisperse PODS).

Generally, a system for processing a sample may include a chamber having at least one inlet and at least one outlet, where the chamber is configured to accommodate flow of the sample from the at least one inlet toward the at least one outlet, a filterless and/or lensless imager array configured to image the flow of the sample in the chamber, and at least one light source. The imager array may have a wavelength detection window defining the range (lower and/or upper thresholds) of wavelengths of light that the imager array is able to detect. The at least one light source may be configured to emit light having a wavelength outside the wavelength detection window. In some variations, the wavelength detection window may include a lower threshold of about 350 nm. In some variations, the system may be used to process a sample including at least one POD (e.g., polydisperse PODS).

In some variations, the system may include a plurality of light sources configured to emit light of a plurality of different wavelengths. For example, at least two of the plurality of different wavelengths may be separated by at least about 50 nm. The plurality of light sources may be configured to emit light of different wavelengths according to a predetermined sequence.

Another variation of a method for processing a sample may include receiving a sample in a chamber, wherein the chamber is proximate a filterless imager array having a wavelength detection window, illuminating the sample in the chamber with light having a wavelength outside the wavelength detection, to thereby induce at least a portion of the sample to fluoresce light within the wavelength detection window, and generating at least one image of the sample with the imager array. In some variations, the wavelength detection window may include a lower threshold of about 350 nm. For example, the light illuminating the sample in the chamber may have a wavelength below about 350 nm, to thereby induce fluorescence light having a wavelength of about 350 nm. In some variations, the method may be used to process a sample including at least one POD (e.g., polydisperse PODS).

In some variations, illuminating the sample may include illuminating the sample with light of a plurality of different wavelengths. The plurality of different wavelengths may be separated or spaced apart by any suitable distance, though in an exemplary variation the plurality of different wavelengths are separated by at least about 50 nm. For example, the sample may be illuminated with light having a first wavelength and illuminated with light having a second wavelength, such as according to a predetermined sequence. In some of these variations, the method may include generating a first image associated with illuminating the sample with light having a first wavelength, and generating a second image associated with illuminating the sample with light having a second wavelength, such that the first and second images depict at least a portion of the fluorescence response of the sample at different illumination light wavelengths. The first and second images may be overlaid to enable visualization of the overall fluorescence response of the sample in response to different emitted wavelengths. The method may further include analyzing the sample based on the response of the sample to illumination by light of the plurality of different wavelengths (e.g., using correlation mapping, a trained machine learning model, etc.).

### BRIEF DESCRIPTION OF THE DRAWINGS

FIGS. 1A and 1B depict schematic illustrations of exemplary variations of an assay system for optically processing samples.

FIG. 2A depicts a schematic illustration of a chamber arrangement with an image sensor.

FIG. 2B depicts an exemplary shadow image obtained with an image sensor in the chamber arrangement of FIG. 2A.

FIGS. 3A and 3B depict schematic illustrations of another exemplary variation of a chamber arrangement with an image sensor.

FIG. 4 depicts a flowchart of one variation of a method for processing a sample using marker particles of different sizes.

FIG. 5 depicts a schematic illustration of a method of preparing a sample for processing.

FIGS. 6A-6D depicts schematic illustrations of exemplary marker particles for use in a method for processing a sample.

FIGS. 7A and 7B are shadow images generated in an exemplary application of a method for processing a sample.

FIGS. 8A-8C are shadow images generated in an exemplary application of a method for processing a sample.

FIG. 9 depicts a flowchart of another variation of a method for processing a sample using fluorescent imaging.

FIGS. 10A and 10B depict schematic illustrations of a variation of a method for processing a sample using fluorescent imaging.

FIGS. 11A and 11B are schematic illustrations of sample images associated with illumination of the sample at different wavelengths. FIG. 11C is schematic illustration of an overlay of the images of FIGS. 11A and 11B.

FIG. 12 depicts a flowchart of another variation of a method for processing a sample.

FIG. 13 depicts a schematic illustration of a method of preparing a sample for processing.

FIGS. 14A, 14B, 15A, and 15B illustrate exemplary marker particles with darkness shift and use thereof.

FIGS. 16A-16J depict schematic illustrations of exemplary marker particles.

FIG. 17A depict a flowchart of a variation of a method for making a marker particle capable of darkness shifting. FIG. 17B depicts a schematic illustration of part of the method described in FIG. 17A. FIG. 17C depicts a schematic illustration of a marker particle resulting from the method described in FIG. 17A.

FIG. 18A depicts a flowchart of another variation of a method for making a marker particle capable of darkness shifting. FIG. 18B depicts a schematic illustration of part of the method described in FIG. 18A. FIG. 18C depicts a schematic illustration of a marker particle resulting from the method described in FIG. 18A.

FIG. 19 depicts a schematic illustration of an exemplary application of marker particles with darkness shifting, for processing a sample.

FIG. 20 depicts a schematic illustration of another variation of a marker particle.

FIG. 21 depicts a schematic illustration of another variation of a method for processing a sample in a cell secretion assay.

FIG. 22A depicts a schematic illustration of a marker particle scheme for an enzyme-linked darkening assay. FIGS. 22B-22D depict schematic illustrations of a darkening shift on marker particles of various sizes and shapes.

FIGS. 23A and 23B depict an experimental sample with IgG and a control sample without IgG, respectively. FIG. 23C depicts a violin plot of hue of the imaged samples, illustrating the darkening shift in the experimental sample compared to the control sample.

FIGS. 24A and 24B depict schematic illustrations of another variation of a marker particle before sample exposure and after sample exposure, respectively.

### DETAILED DESCRIPTION

Non-limiting examples of various aspects and variations of the invention are described herein and illustrated in the accompanying drawings.

Generally, described herein are exemplary variations of assay systems and methods for processing samples. For example, such systems and methods may process a large number of entities within the sample substantially in parallel, such as to enable rapid experimental analysis of the sample. Furthermore, the systems and methods described herein may be used to process polydisperse entities of non-uniform size. Generally, the systems and methods described herein may facilitate measurements of diagnostic- and/or research-related events or sample characteristics, such as agglutination, colloidal stability, cell growth, cell surface profiling, cell size profiling, and/or the profiling of concentration of proteins, antibiotics, nucleotides, other analytes, and the like. Applications may include diagnostics, drug research, environmental research, and the like.

### PODS

As described in further detail below, the systems and methods may, for example, process partitioned samples. For example, the systems and methods may process suitable experimental dispersion, a type of which is also referred to herein as Polydisperse Oblate Dispersion System “PODS” A POD may include in its body any suitable experimentally useful content, such as cells, DNA, RNA, nucleotides, proteins, enzymes, and/or any suitable chemical and/or biological content for analysis. In other examples, a POD may include reagents that are used to confer signals to one or more image sensors such that the PODS may be processed by software to yield meaningful chemical and/or biological information. Suitable reagents or agglutinates may include, for example, beads coated with gold, latex, cellulose, agarose, polystyrene, magnetic, and/or other materials bound to biologically active proteins or scaffolds (e.g., materials suitable for ELISA kits and agglutination assays such as cell surface binding and cell agglutination assays). Additionally, in some variations (e.g., for samples with cell cultures), a substance such as L-glutamine may be encapsulated in the PODS so as to help keep cells viable. Furthermore, in some variations, as further described below, PODS may include hydrogels or a porous solid or polymeric phase that serve as an anchor for a capture protein or antibody. A sandwich type assay can then be constructed with a sample that is specific to the capture protein, and a second detection antibody that is bound to a detection catalyst or enzyme such as Horse Radish Peroxidase, HRP. A darkening substrate such as PCIB can then be added.

For example, a POD could include any such bead having a size between about 10 nm to about 50 and coated with a biomarker (e.g., antibody). The degree of agglutination resulting from self-aggregation of such reagents or agglutinates (which may be monodisperse or polydisperse) in the assay system described herein may, for example, enable inference of protein and/or analyte concentrations. Thus, analytes of interest include, but are not limited to, various chemical and/or biological mixtures including buffers, cells, tissues, lysates, agglutinates, aggregate proteins, drugs, antibodies, nucleotides, dyes, and/or coated particles, etc.

In some variations, each POD may be considered a separate experiment, such that processing of multiple PODS enables the fast and efficient performance of multiple experiments in parallel. Processing PODS may involve, without limitation, analyzing one or more characteristics of PODS, tracking location and/or predicting trajectory of PODS within the chamber, and/or manipulating PODS for sorting.

In some variations, a POD may include an aqueous phase that is stabilized and is transportable in a surrounding medium such as a liquid or other fluid (e.g., a non-aqueous solution containing a surfactant or lipid, or mixture thereof). In some variations, a POD being processed by the assay device may be distinct from a droplet at least in part because a POD is not spherical. For example, a processed POD might not be spherically symmetrical. The processed POD may be smaller in one dimension (e.g., in a dimension measured generally orthogonal to an electrode surface as described below) than in another dimension. For example, the processed POD may be generally flattened on at least one side, similar to a generally hemi-spherical shape, or may be generally flattened on at least two opposing sides, similar to a disk-like or “pancake” shape. As described in further detail below, a POD that is flattened on at least one side may have increased surface area of contact with measurement electrodes in the assay device, such that electrode measurements may have reduced noise and generally improved signal quality. Additionally, as described in further detail below, a POD that is flattened on at least one side may be volumetrically restricted so as to concentrate the POD contents into a shape approximating a two-dimensional focal plane of a camera, thereby improving visibility of the POD contents by the camera. Furthermore, a POD may be distinct from a droplet at least in part because multiple PODS being processed simultaneously by the assay device may be polydisperse, in contrast to droplets which are conventionally thought of as being the same size (e.g., having monodisperse characteristics).

For example, a POD may be pressed into a flattened form (e.g., by mechanical compression between two plates, between opposing surfaces of a chamber such as that described below, or other suitable mechanism), by increasing surfactant concentration, or in any suitable manner.

The surrounding medium for the PODS may, for example, include a non-aqueous continuous phase. In some variations, the surrounding medium may be fluorous. For example, the medium may include a fluorinated oil or other liquid (e.g., HFE 7500 available as Novec™ manufactured by 3M′ or FC-40, available as Fluorinert™ manufactured by 3M). As another example, the medium may include hydrocarbon oil. The medium may, in yet other variations, additionally or alternatively include PEG and fluoridated derivatives (e.g., derivatives of Krytox™ fluorinated oils manufactured by The Chemours Company, which may be polymerized or co-polymerized with PEG or other suitable glycol ethers), and may include lipids or other phosphoric, carboxylated or amino-terminated chains.

In some variations, a POD may have an overall density that is lower than the density of the surrounding medium, such that aqueous PODS within the medium are more buoyant and tend to rise within the surrounding medium. For example, the surrounding medium may include a fluid denser than water, such as HFE-7500 and/or FC-40, which may be mixed with co-block polyethylene glycol/Krytox™ polymer. In other variations, a POD may have an overall density that is higher than the density of the surrounding medium such that aqueous PODS within the medium are less buoyant tend to sink within the surrounding medium. For example, the surrounding medium may include a fluid less dense than water, such as hexadecane and a phospholipid bilayer. In yet other variations, a POD and its surrounding medium may have substantially similar or equal densities. It should be understood that various combinations of relative densities of PODS and the surrounding medium may provide varying levels of buoyancy of the PODS within the surrounding medium (e.g., a set of PODS within a particular medium may include some PODS that tend to rise and some PODS that tend to sink). For example, relative buoyancy of the PODS may be beneficial in some applications to leverage gravity in sorting of PODS. However, the POD may be surrounded by any suitable medium.

One or more PODS may be introduced in combination with a suitable surrounding medium as an emulsion into an assay device and processed as described herein. In some variations, mixing to create PODS may occur outside of the assay device (e.g. adjacent an external side of an inlet of the device prior to introduction into the device), while in other variations such mixing may additionally or alternatively occur inside the assay device. For example, PODS may be generated by agitating (or vortexing, stirring, repeatedly pipetting, etc.) at least two solutions including a biological reagent (e.g., detection reagent) and a fluorinated liquid or other encapsulation reagent. Furthermore, larger PODS may be transformed into smaller PODS (e.g., by interaction with spacers in the assay device as described below, or interaction with any other suitable device feature) to control or adjust polydispersity among the PODS.

In some variations, the preparation of PODS (e.g., with a sample, a detection reagent, and/or an encapsulation reagent) may be similar to any of those described in further detail in U.S. patent application Ser. No. 16/596,688, which is hereby incorporated herein in its entirety by this reference.

The assay devices and methods may be used to process polydisperse sample entities. For example, various aspects of the devices and methods described herein may enable substantially simultaneous processing of PODS of different sizes, in contrast to conventional systems which require samples to be monodisperse. In some variations, the assay devices and methods described herein may simultaneously process sample entities having at least 5%, at least 10%, at least 25%, or at least 50% variance in size (e.g., POD diameter, POD circumference, POD surface area, POD volume, etc.). The ability to handle polydisperse samples may, for example, provide sample analysis that is simpler and more efficient (e.g., by not requiring the sample entities to be sorted by size in a separate, time-consuming process before introducing them into an assay device).

Exemplary applications of the assay devices and methods described herein include processing PODS to measure analyte concentration, measure cell division, measure morphology, size, and/or number of cells or particles within a POD or other sample entity, measure relative sizes of cells (and/or agglutinates) and the PODS within which they are contained (e.g., ratio between circumference of a POD and the circumference of a cell within the POD), and the like. For example, the devices and methods may be used for pathology, oncology, determining white or red blood cell counts, etc. Furthermore, the assay devices and methods described herein may be used to perform any of a wide variety of agglutination tests.

### Assay System for Processing a Sample

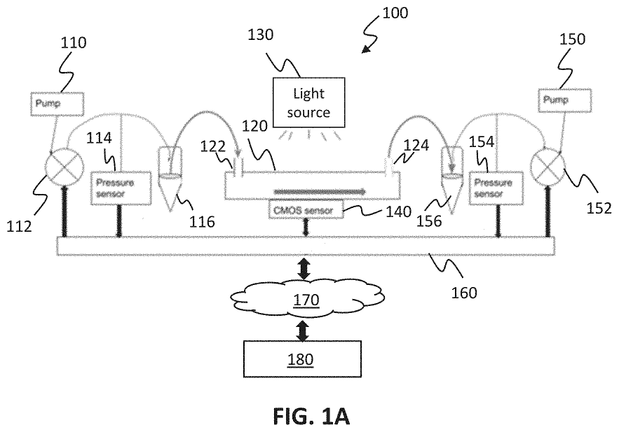

Generally, as shown in the schematic of FIG. 1A, in some variations, an assay system 100 for processing a sample includes a chamber 120 having at least one inlet 122 and at least one outlet 124, wherein the chamber is configured to accommodate flow of the sample from the at least one inlet toward the at least one outlet, and an imager array 140 configured to image the flow of the sample in the chamber 120. For example, a sample (e.g., a plurality of PODS) may be placed in a reservoir 116 (e.g., Eppendorf tube or other suitable receptacle) for introduction into the chamber 120 through one or more inlets 122. The imager array 140 may include at least one lensless image sensor configurable opposite at least one light source 130. In some variations, the assay system 100 may include a fluidic control system with one or more pumps, valves, and/or fluid sensors to manipulate flow of the sample. The system 100 may further include an electronics system 160 (e.g., PCBA with one or more processors, etc.) configured to control and/or receive signals from other components of the assay system 100, as further described below. In some variations, the electronics system 160 may further include one or more communication components (e.g., Bluetooth, WiFi, etc.) configured to communicate data (e.g., image data) to a network 170 for analysis by one or more remote processors 180. Additionally or alternatively, at least some of the data may be analyzed by one or more processors located in the electronics system 160.

Furthermore, one or more processors may be configured to execute the instructions that are stored in memory such that, when it executes the instructions, the processor performs aspects of the analytical methods described herein. The instructions may be executed by computer-executable components integrated with the application, applet, host, server, network, website, communication service, communication interface, hardware/firmware/software elements of a user computer or mobile device, wristband, smartphone, or any suitable combination thereof. The instructions may be stored on memory or other computer-readable medium such as RAMs, ROMs, flash memory, EEPROMs, optical devices (e.g., CD or DVD), hard drives, floppy drives, or any suitable device. Furthermore, the one or more processors may be incorporated into a computing device or system, such as a cloud-based computer system, a mainframe computer system, a grid-computer system, or other suitable computer system.

FIG. 1B depicts a schematic of an exemplary variation of a system 100 for processing a sample including a chamber 120 configured to receive a sample (e.g., emulsion) from a reservoir 116 (e.g., Eppendorf tube, other suitable receptacle, etc.) coupled to an inlet of the chamber 120. The chamber 120 may be arranged between one or more light sources 130 and an imager array such that the imager array may produce optical shadow images of the sample within the chamber 120. The images may be analyzed using techniques such as those described herein, the sample may be processed (e.g., characterized and output into one or more waste containers such as a reservoir 156 and/or other receptacle 156′ (e.g., Eppendorf tube). Furthermore, the system 100 may include a robotic or automated pipette 190 for drawing portions of the sample that may be of interest for further analysis or other processing.

### Chamber Arrangement

As described above, the assay system may include a chamber having at least one inlet and at least outlet, and may be configured to accommodate flow of the sample from the at least one inlet toward the at least one outlet. Generally, the chamber may be configured to accommodate a two-dimensional flow of the sample, such that PODS (or other entities in the sample) may circulate within the volume of the chamber (e.g., in multi-directional flow). For example, the chamber may include a generally rectangular volume. In some variations, the chamber may be defined at least partially by a first structure and a second structure opposing the first structure, where each of the first and second structure has at least a portion that is optically transparent.

Furthermore, at least one light source may be positioned on one side of the sample flow in the chamber, and an imager array including at least one image sensor may be positioned on the other side of the sample flow (opposite the light source) in the chamber. In such an arrangement, the imager array may be configured to generate “shadow images,” or images through shadowgraphy, of chamber contents that are backlit by the at least one light source. Information (e.g., chemical and/or biological information) about samples may be derived from such shadow images of the samples.

In some variations, the assay device may additionally or alternatively include one or more electrodes configured to measure electronic characteristics of samples (e.g., perform impedance measurements that may be correlated to chemical and/or biological information about the samples, for example) and/or generate electrical fields to enable dielectrophoresis. For example, the chamber may include electrodes similar to those described in U.S. patent application Ser. No. 15/986,416 which is hereby incorporated in its entirety by this reference. Additional examples of such electrodes are described in further detail below, with respect to exemplary variations of chamber arrangements.

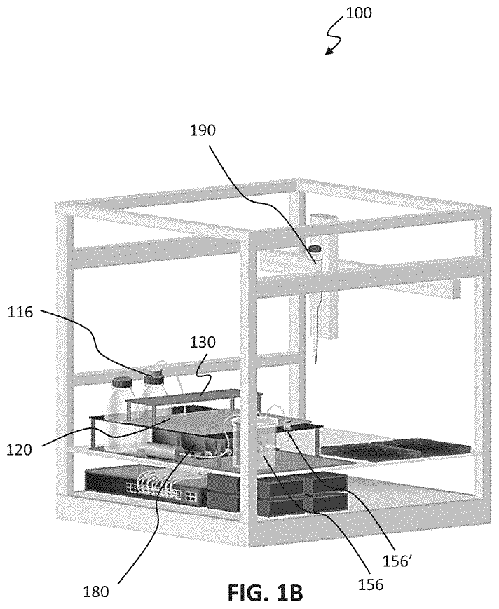

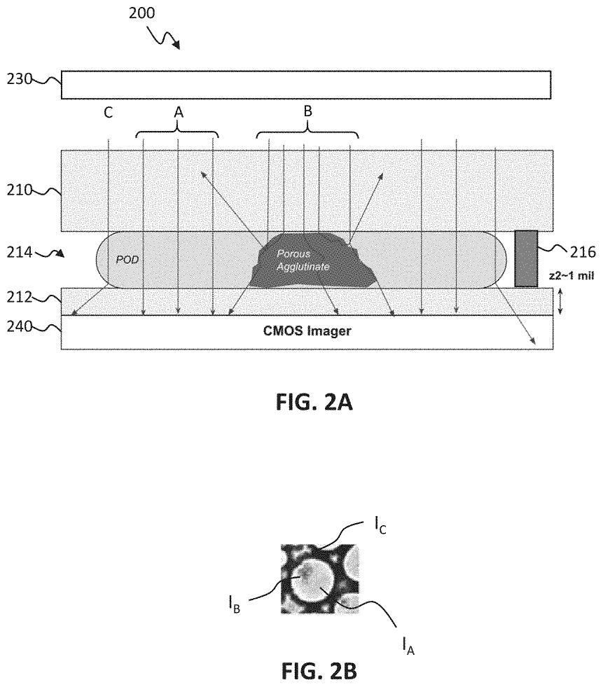

Generally, as shown in the cross-sectional view schematic of FIG. 2A, a chamber arrangement may include a chamber 200 having a first structure 210 and a second structure 212, where the first and second structures include an optically transparent material and are offset from each other to form a gap 214 or at least partially defining a chamber volume. Spacing between the first structure 210 and the second structure 212 may, in some variations, be supported or enforced by one or more spacers 216 as further described herein. Thickness of spacers may be determined to, for example, adjust chamber height and/or operational parameters such as emulsion stability, POD flow rate, etc. In some variations, chamber height may be at least part based on the kind of PODS or sample desired to be analyzed. Suitable chamber heights may range, for example, between about 0.1 μm to about 200 μm. For example, some PODS may include cells that may be best analyzed using a chamber having a taller height such as 25-30 μm, while some PODS may include proteins that may be best analyzed using a chamber having a shorter height such as less than 1 μm.

A light source 230 may be positioned on one side of the chamber and be configured to emit light toward the gap 214. In some variations, an imager array 240 with a lensless image sensor (e.g., CMOS imager) may be positioned on the other side of the chamber, opposite the light source 230, and configured to image the region of the gap 214. Specifically, the lensless image sensor may be placed directly on the chamber (or alternatively used to directly form the boundary of the chamber), without an objective lens or other optical focusing lenses in the line of sight between the lensless image sensor and the chamber. The first structure 210 and the second structure 212 may include an optically transparent material, such that light from the light source 230 may pass through an optically transparent portion of the first structure 210, travel across the gap 214, pass through an optically transparent portion of the second structure 212, and be incident on the imager array 240.

A sample may flow through the chamber 200 in the gap 214, as represented in FIG. 2A as a POD passing through gap 214. For purposes of illustration, the POD can include an analyte such as an agglutinate, as shown in FIG. 2A, though it should be understood that a POD can include other kinds of analytes (or no analyte). Light from the light source 230 may be emitted toward the chamber (and toward the POD within the chamber) and interact with the POD and its contents when the POD is in the chamber. The imager array 240 may be configured to detect and image the optical phenomena resulting from these interactions, including, for example, shadows, absorbance or emission spectra (e.g., fluorescence), extinction coefficient, light scattering, etc.

For example, FIG. 2A illustrates a system in which the imager array 240 is configured to generate shadow images of the sample flow in the chamber. The light source 230 may be configured to emit light (e.g., visible light) toward the sample flow. As shown in FIG. 2A, some light rays (e.g., light rays “A”) may enter the chamber and pass through the aqueous portion of the POD relatively undisturbed, which causes the aqueous portion of the POD to be imaged by the imager array 240 as a bright, backlit region (e.g., region I_{A} in FIG. 2B). Some light rays (e.g., light rays “B”) may enter the chamber and be scattered or reflected due to the agglutinate (or other analyte(s)) in the POD, which causes the agglutinate (or other analyte(s)) to be imaged by the imager array 240 as a somewhat darkened, indefinite or “fuzzy” region (e.g., region I_{B} in FIG. 2B). In some variations, information about the POD and its contents, such as size, shape, and/or density of the agglutinate, may be determined based at least in part on the darkened, indefinite region of the image (e.g., based on size, shape, pixel intensity, etc. of the region). Furthermore, some light rays (e.g., light rays “C”) may enter the chamber and undergo diffraction at the POD boundary, which causes the POD boundary to be imaged as a dark, shadowed border region (e.g., I_{C} in FIG. 2B). In some variations, the overall shape and/or size of the POD may be determined based at least in part on the border region (e.g., shape, size, pixel intensity, etc. of the border region). Accordingly, one or more lensless image sensors in the imager array 240 may be configured to generate “shadow images” of the backlit contents of the chamber. Chemical and/or biological properties may be derived from these shadow images.

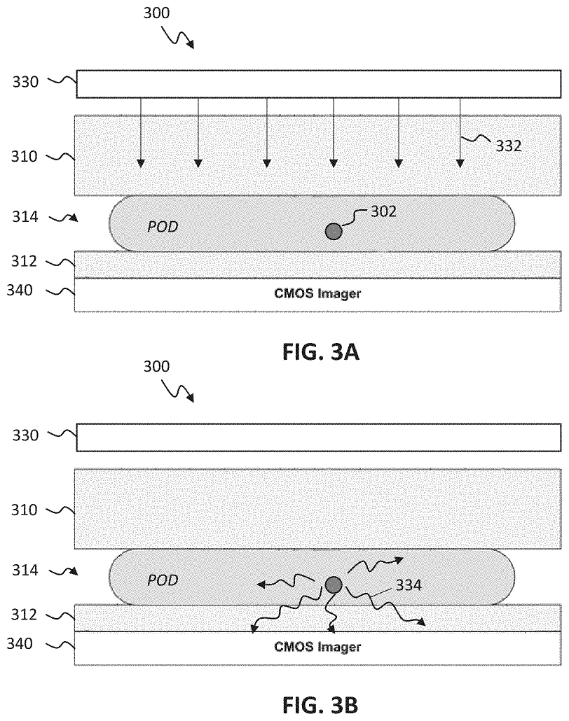

FIGS. 3A and 3B illustrates another exemplary variation in which the imager array additionally or alternatively configured to fluorescent images of the sample flow in the chamber. FIGS. 3A and 3B illustrate a chamber arrangement similar to the chamber arrangement described above with reference to FIG. 2A, except as described below. As shown in FIG. 3A, the light source 330 may be configured to emit light 332 suitable for inducing fluorescence or other emission spectra toward the sample flow. The emitted light 332 may, for example, include ultraviolet light (UV). At least some PODS in the sample flow may include a bead or biological sample 302 or other substance configured to absorb the emitted light and emit light in response (e.g., of a different wavelength). For example, as shown in FIG. 3B, at least some emitted light may be absorbed by a POD or contents therein, which may in turn emit fluorescence or other light emission 334. The emitted fluorescence may be imaged as a fluorescent image by at least a portion of the image sensors in the imager array 340. Chemical and/or biological properties may be derived from these fluorescent images (e.g., based on wavelength of emitted light, intensity of emitted light, etc.).

In some variations, the imager array may lack an external filter (e.g., Bayer filter), such that one or more image sensors in the imager array receive all incident light. In conventional devices, filters are used to select wavelengths for detection by image sensors that are coupled to such filters. These filters are necessary in conventional devices to distinguish between light signals (e.g., different wavelengths of light) and allow conventional optical imaging arrangements to wavelength-specific images (e.g., such that wavelength-specific information may be derived from the images). However, a filterless lensless imager array as used and described herein, can advantageously provide desired optical imaging functionality for sample processing without such filters, thereby avoiding bulk, cost, and specialized manufacturing processes associated with such filters. For example, variations of sample processing methods, as described in further detail below, advantageously leverage characteristics of a filterless imager array while enabling processing of a sample (e.g., for analyzing a single analyte in the sample, or multiple analytes in the sample in a multiplexed manner).

Furthermore, although the chamber arrangement of FIGS. 3A and 3B depict an imager array 340 that is opposite the light source 330 emitting light for inducing fluorescence, it should be understood that in other variations, the imager array 340 may be located in any suitable location proximate the light source 330 so as to capture fluorescence or other emission spectra from the sample flow. For example, at least a portion of the imager array 340 and at least a portion of the light source 330 may be orthogonal to each other (e.g., one on a side wall of the chamber 300, the other on an upper structure or lower structure of the chamber 300). As another example, additionally or alternative, at least a portion of the imager array 340 and at least a portion of the light source 330 may be adjacent to each other (e.g., on the same surface such as on the upper structure or lower structure, in an alternating or other distributed pattern).

In some variations, the chamber arrangement may be similar to any one or more chamber arrangements described in further detail in U.S. patent application Ser. No. 16/596,688 which is hereby incorporated herein in its entirety by this reference.

### Multiplexed Sample Analysis

In some variations, the chamber arrangements described herein (e.g., as shown and described above, such as with reference to FIGS. 1-3B and combinations thereof) may be used to analyze multiple analytes in parallel, in a multiplexed manner within a single chamber arrangement.

### Marker Particle Sizes/Shapes

As described in further detail below, some methods for processing a sample in a multiplexed manner may utilize different marker particles, such as multiple markers (e.g., beads coated with gold, latex, cellulose, agarose, polystyrene, magnetic, and/or other materials) of different sizes and/or marker constructs including combinations of different-sized markers. Any suitable dimensional metric (e.g., diameter, circumference, etc.) may be used to characterize the size of a marker particle.

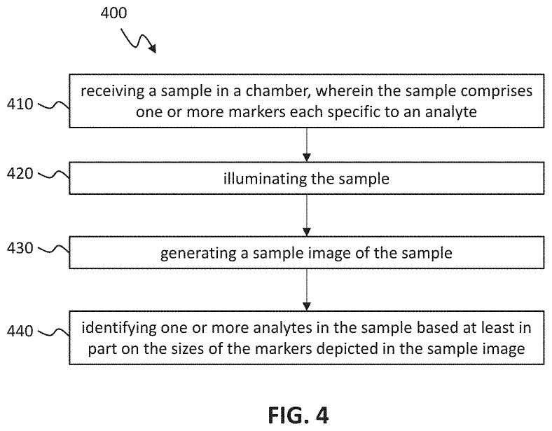

For example, as shown generally in FIG. 4, in some variations a method 400 for processing a sample includes receiving a sample in a chamber 410 wherein the sample comprises one or more markers each specific to an analyte, illuminating the sample 420, generating a sample image of the sample 430, and identifying one or more analytes in the sample 440 based at least in part on the sizes of the markers depicted in the sample image. Accordingly, in some variations the method may enable parallel processing (e.g., identification and further analysis) of one or multiple analytes using size-discriminated objects. In some variations, other characteristics of the markers as depicted in the sample image (e.g., grayscale values) may additionally or alternatively be used to discriminate between marker particles and their respective specifically-binding analytes. The chamber used with the method 400 may, for example, be one of the chamber arrangements described above (e.g., including an imager array configured to generate optical shadow images of the sample in the chamber). Accordingly, a sample flow with multiple marker particles and analytes in such a chamber can be imaged and analyzed with high throughput and efficiency. Although the method 400 and markers for use in the method 400 are primarily described with respect to agglutination in the presence of analytes of interest, it should be understood that other mechanisms (e.g., precipitation) can additionally or alternatively be used to signify analytes of interest.

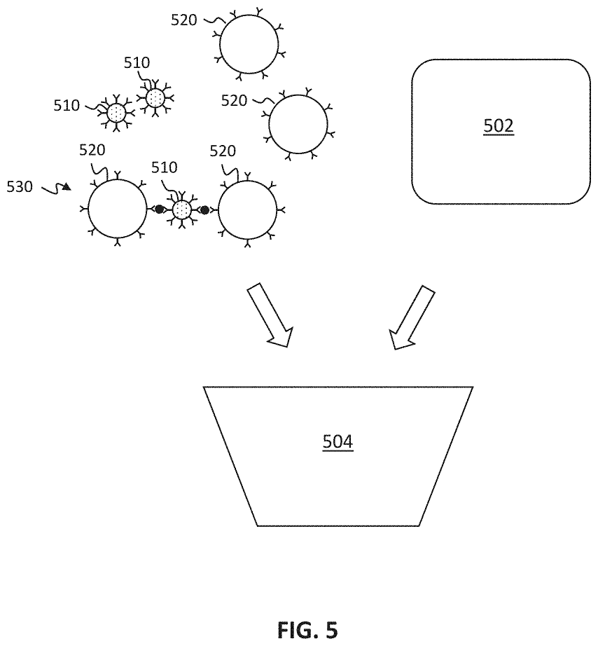

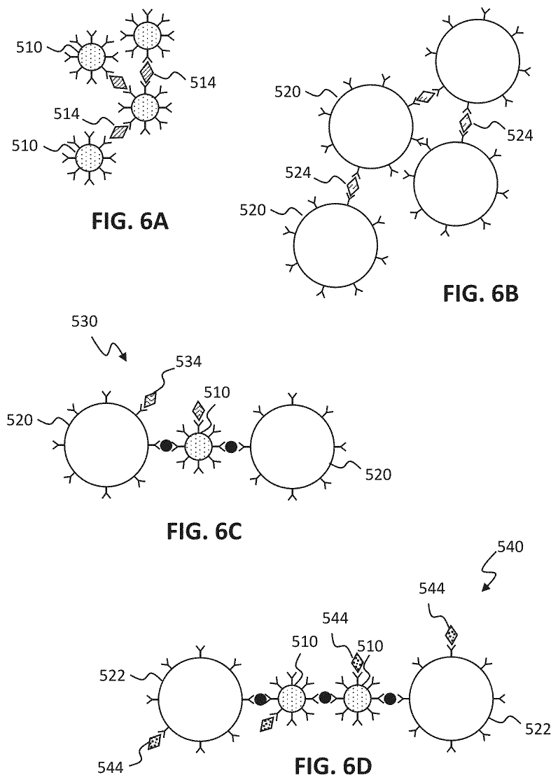

Exemplary preparation of a sample for use in the method 400 is illustrated in FIG. 5. As shown in the schematic of FIG. 5, a sample 502 with one or more analytes can be combined with marker particles of varying types, such as in a mixing vessel 504. The combination of the sample 502 and marker particles can be mixed in any suitable manner, such as with agitation, vortexing, stirring, repeated pipetting, etc. In some variations, the sample 502 can include at least a first analyte, second analyte, and/or third analyte. The marker particles can include one or a plurality of first markers each having a first size, one or a plurality of second markers each having a second size different from the first size, and/or one or a plurality of marker constructs comprising markers of different sizes. Each marker particle type may be specific to a different analyte by virtue of biomarkers (e.g., a marker particle may be coated with an antigen that specifically binds to an antibody of an analyte of interest, or vice versa). For example, by way of illustration, the marker particles can include one or more of a plurality of first markers 510 of a small size, a plurality of second markers 520 of a larger size, and a plurality of marker constructs 530 including at least one first marker 510 combined with (e.g., bound to) at least one second marker 520. As shown in FIG. 6A, each first marker 510 may be specific to a first analyte 514 such that a plurality of first markers 510 is configured to signify the presence of (e.g., agglutinate in the presence of) the first analyte. Similarly, as shown in FIG. 6B, each second marker may be specific to a second analyte 524 such that a plurality of second markers 520 is configured to signify the presence of (e.g., agglutinate in the presence) of the second analyte.

As shown in FIG. 6C, an exemplary marker construct 530 may include a combination of one or more first markers 510 combined with one or more second markers 520, where the first and second markers (and hence the marker construct 530) may be specific to a third analyte 534. A plurality of the marker constructs 530 may be configured to agglutinate in or otherwise signify the presence of the third analyte. One or more first markers 510 and one or more second markers 520 can be bound by, for example, an antigen-antibody interaction or other suitable chemical coupling. Although the individual markers comprising the marker construct 530 may move relative to each other, they generally move collectively together since they are bound in the marker construct. Accordingly, a certain set of individual, separate marker types (e.g., two larger markers and one smaller marker) can be distinguished from the same set of marker types joined together as part of a marker construct, based on synchronized movement of the markers.

Although the marker construct 530 as shown in FIG. 6C includes two larger markers 520 joined by an intervening smaller marker 510, other variations of marker constructs may include one or more first markers and one or more second markers combined in any suitable unique and identifiable pattern arrangement, such that different marker constructs can be distinguished from each other based on the arrangement of the markers forming the marker construct. For example, as shown in FIG. 6D, another marker construct 540 includes two larger markers 520 joined to an intervening pair of smaller markers 510, and the marker construct 540 may be specific to a fourth analyte 544. It should be understood that additional types of marker particles are possible, as individual markers may be any suitable size (e.g., beads of 100 nm, 500 nm, 1 μm diameter, etc.) and may be arranged in any suitable combination and permutation to form other types of marker constructs.

As each marker particle type (e.g., type of marker or type of marker construct) may be specific to a respective analyte, each marker particle may be configured to agglutinate when in the presence of its respective analyte. Accordingly, generally, an image of a sample having one or more analytes may be analyzed to identify the one or more analytes based on the identification of marker particles bound to the analytes. For example, with reference to FIG. 4, the method 400 includes illuminating the sample 420 with at least one light source and generating a sample image 430. The sample in the chamber may be imaged with an imager array located generally opposite the light source so as to obtain a shadow image of the sample, where the image may depict one or more marker particle types. One or more analytes in the sample may be identified (and further analyzed for other attributes) based at least in part on the sizes of the marker particles as depicted in the sample image. In other words, each resulting agglutination type (e.g., agglutination in the presence of the first analyte, or agglutination in the presence of the second analyte) may be identified by virtue of a unique shadow “barcode”, or shadow identifier corresponding to the size(s) of the markers in the marker particles and/or marker constructs participating in the agglutination. Multiple shadow identifiers may be used in parallel to enable multiplexed analysis of multiple analytes of interest.

For example, in some variations as described above, a first marker may have a first size and may be specific to a first analyte. A second marker may have a second size different from the first size and may be specific to a second analyte. In such variations, the method may include distinguishing between the first analyte and the second analyte by determining whether an imaged object (which may be part of a mass resulting from presence of the first or second analyte, such as through agglutination or precipitation) in the sample image is, or includes, the first marker or the second marker. For example, a sample image may be pre-processed (e.g., reducing noise, removing background colors, etc.) to facilitate a clearer image of the sample in which features of the sample (e.g., PODS and contents thereof) are more easily distinguishable. The size of an imaged object, such as a feature contained within a POD, may be measured and compared to the first size and/or the second size using suitable machine vision techniques. Sufficient size similarity between the imaged object and the first size (e.g., substantially equal, within a predetermined threshold) suggests that the imaged object may be the first marker, and may indicate the presence of the first analyte in the sample, though the analyte itself may not be visible in the image. Similarly, sufficient size similarity between the imaged object and the second size suggests that the imaged object may be the second marker, and may indicate the presence of the second analyte in the sample. Furthermore, the degree of agglutination among multiple first markers (or multiple second markers) can be determined and further analyzed (e.g., degree of agglutination and/or precipitation may be correlated to amount of analyte in the sample).

As another example, in some variations as described above, a marker construct may include a combination of multiple markers of different sizes (e.g., one or more first markers of a first size combined with one or more second markers of a second size different from the first) in a known arrangement, and the marker construct may be specific to a third analyte. In such variations, the method may include identifying the third analyte in the sample by determining whether an imaged object in the sample image includes the multiple markers in the known arrangement (e.g., whether the imaged object includes the one or more first markers and one or more second markers). The known arrangement may be identified by measuring sizes of multiple imaged objects and comparing each measurement to marker sizes, and/or by determining synchronized movement of adjacent imaged objects. Movement of imaged objects may be determined, for example, by analyzing images of the sample taken in sequential order. For example, movement of adjacent imaged objects may be considered synchronized if the distance between adjacent imaged objects remains generally equal across multiple sequential images, which may suggest that the adjacent imaged objects are joined together. Furthermore, different marker construct types can be distinguished based on relative sizes and positions of different-sized markers that are moving in synchrony.

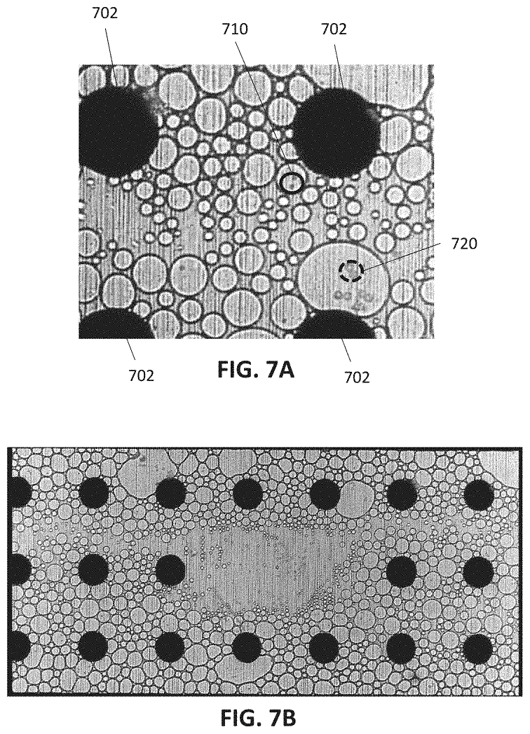

FIGS. 7A and 7B are exemplary shadow images depicting different marker particle types in a sample flow of polydisperse PODS. For example, as shown in the shadow image of FIG. 7A, circle 710 highlights two smaller polystyrene beads having a diameter of 10 μm, while circle 720 highlights two larger polystyrene beads having a diameter of about 20 μm. The beads are contained within PODS flowing through a chamber similar to that described above with respect to FIG. 2A, around spacers 702 within the chamber. The smaller 10 μm beads and the larger 20 μm beads can be distinguished by their imaged size. Additionally or alternatively, the smaller and larger beads may be distinguished from each other based on other imaged characteristics, such as grayscale or intensity value. The smaller 10 μm beads appear dark and filled in, while the larger 20 μm beads appear outlined as a ring or “halo.” This difference in appearance in the sample image may be due to the relative dimensions of the wavelength of illuminating light and size of the bead. As shown in the sample flow of FIG. 7B, many polydisperse PODS may be similarly imaged and analyzed. Some PODS contain one or more of the smaller 10 μm beads, some PODS contain one or more of the larger 20 μm beads, some PODS contain both kinds of beads, and some PODS do not contain either kind of bead. In other applications, the smaller 10 μm beads may be specific to bind to a first analyte, while the larger 20 μm beads may be specific to bind to a second analyte. In these applications, the agglutination of the smaller 10 μm beads and agglutination of the larger 20 μm beads can be identified, measured, and correlated to amounts (e.g., concentration) of the first and second analytes, respectively.

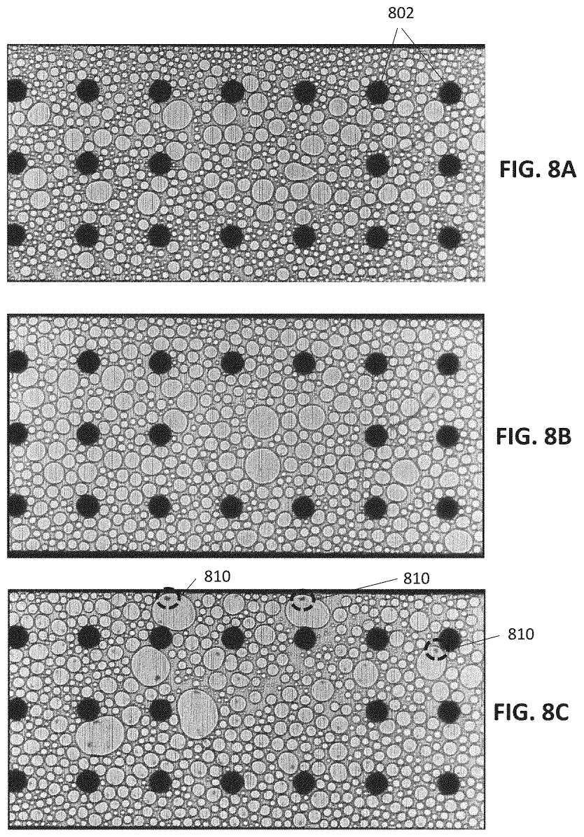

In some variations, smaller marker particles may not be visible in the sample image due to their size (e.g., if a marker particle size is less than the pixel size). However, they may be visible in the sample image upon agglutination and/or their presence may be inferred based on their association with larger visible marker particles. Thus, any analytes that are bound to particularly small marker particles may still be identified (and subsequently analyzed) by identifying the aggregate agglutination effect and/or effect with other larger particles. As an illustrative example, FIGS. 8A-8C are exemplary shadow images of PODS flowing through in a chamber similar to that described above with respect to FIG. 2A, around spacers 802 within the chamber. Pixel size of the images of FIGS. 8A-8C is about 1.4 μm. Specifically, FIG. 8A is a shadow image depicting PODS containing 960 ng/ml IgG but no anti-IgG beads (markers specific to bind to IgG in the sample). FIG. 8B is a shadow image depicting PODS containing 1 μm anti-IgG beads. Both IgG and the anti-IgG beads are not visible in the shadow images due to their size (smaller than the pixel size). FIG. 8C is a shadow image depicting PODS containing 480 ng/ml IgG and 1 μm anti-IgG beads. The anti-IgG beads cluster in the presence of the IgG, such that their aggregated mass is visible in the shadow image, as highlighted by circles 810.

Thus, as described above, multiple marker particles of different sizes (e.g., markers, marker constructs comprising combined individual markers) can be specific to different respective analytes. Different marker particles, mixed into a sample with different analytes that specifically bind to the marker particles, can be distinguished by imaging the sample flow and identifying the sizes and/or other distinct imaged characteristics of marker particles. Such identification of marker particles in the image allows identification and subsequent analysis of multiple different analytes. Thus, introduction and imaging of such multiple marker particles into a sample advantageously can permit simultaneous or parallel identification of the different analytes in a single chamber. It should be understood that while the markers are primarily described above as being distinct as a result of having different sizes (e.g., beads of different diameters), in some variations markers may additionally or alternatively be distinct as a result of having different shapes (e.g., spherical vs. ellipsoid).

### Enzyme-Linked Darkening Assay

As further described below, some methods for processing a sample (e.g., in a multiplexed manner) may utilize marker particles, such as markers (e.g., beads, constructed markers as described below, etc.) that experience a shift in darkness in their imaged appearance when in the presence of specific analytes. For example, as described in further detail below, the darkness shift may be the result of a change in color, intensity, and/or other optical appearance due to consumption of a darkening reagent (e.g., enzyme substrate) that is introduced when an analyte of interest is present, which may result in precipitation in and/or around the marker surface that at least partially blocks light and creates a darkness shift in their appearance as imaged by shadow imaging described above. This change in appearance indicates that the analyte of interest is present. When different marker particles are specific to different analytes of interest and have different forms (e.g., size, shape, materials, shape or size of marker particle portions such as shadow identifiers as described below, etc.) and/or other distinguishing optical characteristics forming a shadow, these marker particles can be used to permit simultaneous or parallel identification of different analytes in a single chamber.

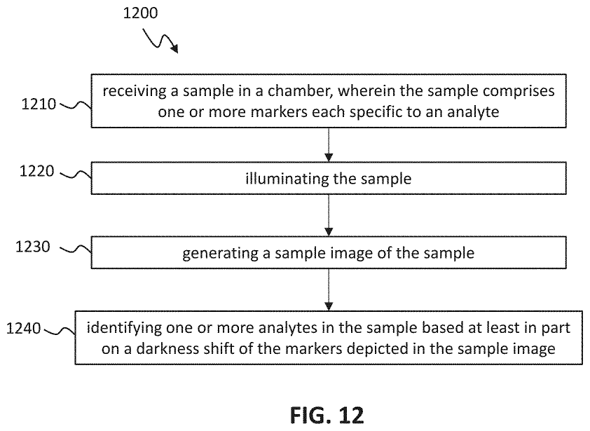

For example, as shown generally in FIG. 12, in some variations, a method 1200 for processing a sample includes receiving a sample in a chamber 1210 wherein the sample comprises one or more marker particles each specific to an analyte, illuminating the sample 1210, generating a sample image of the sample 1230, and identifying one or more analytes in the sample 1240 based at least in part on a darkness shift of the one or more marker particles depicted in the sample image. Different marker particle types may be distinguishable through shadow imaging as described herein, due to having different forms such as sizes, shapes, etc. When a darkening reagent is introduced when an analyte of interest is present, a marker particle specific to that analyte (or a portion of the marker particle) may become darker by one or more mechanisms described herein. The visible shift in darkness of a marker particle that is specific to a particular analyte of interest may be detected, and the detected shift in darkness may thus indicate the presence of the analyte. Similarly, a visible shift in darkness of multiple distinctly-formed marker particle types that are specific to different respective analytes of interest may be detected, and this detected shift in darkness may thus indicate the presence of multiple analytes. Accordingly, in some variations the method may enable parallel processing (e.g., identification and further analysis) of one or more multiple analytes using darkness shift of marker particles,

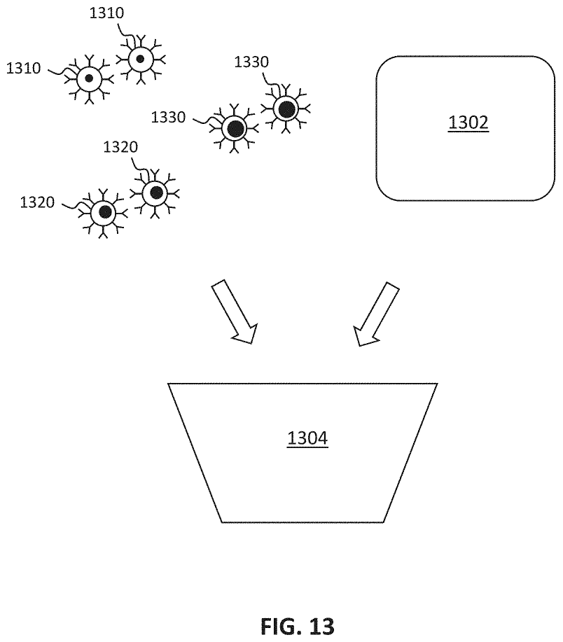

Exemplary preparation of a sample for use in the method 1200 is described in part by the flowchart in FIG. 12. As shown in the illustrative schematic of FIG. 13, a sample 1302 with one or more analytes can be combined with marker particles of varying types, such as in a mixing vessel 1304. The mixing can create PODS, as described above, which may be subsequently passed into a chamber for analysis, such as the chamber arrangement described above. The combination of the sample 1302 and marker particles can be mixed in any suitable manner such as with agitation, vortexing, stirring, repeated pipetting, etc. In some variations, the sample 1302 can include at least a first analyte and a second analyte (and a third analyte, etc.). The marker particles can include a plurality of first markers 1310 having a first form, a plurality of second markers 1320 having a second form, and a plurality of third markers 1330 having a third form, where the first form, second form, and third form are different. The sample 1302 may additionally be combined with more marker types having distinct forms and being specific to different analytes.

Marker Particles with Darkness Shift

Each marker particle type may be specific to a different analyte by virtue of biomarkers. For example, a marker particle may include one or more features (e.g., capture antibodies) to enable the marker particle to be specific to an analyte such as a protein or peptide of interest (e.g., antibody, cytokine, etc.). Such features may be arranged in or around a capture surface of the marker particle, as described in further detail below.

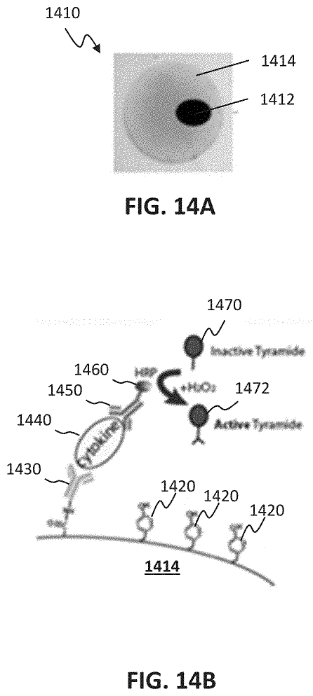

Additionally, each marker particle type may be characterized by a unique shadow identifier (similar to a “barcode”) which may be observable with shadow imaging similar to that described herein. In some variations, as shown in FIG. 14A, the shadow identifier may be based on, for example, one or more bodies 1412 located within the volume of the marker particle type. The one or more bodies 1412 may be at least partially covered with a capture material 1414 which may include a capture surface. The one or more bodies 1412 may include substances such as a bead (e.g., cellulose, agarose, polystyrene, dextran, metals such as gold, nickel, or iron, etc.) or a body shaped through suitable semiconductor manufacturing techniques such as those described below. The body 1412 may, for example, include an opaque or semi-opaque material, so as to appear visible in a shadow image. Additionally or alternatively, in some variations, the shadow identifier may be based on the overall marker particle form (e.g., the form of the capture material 1414).

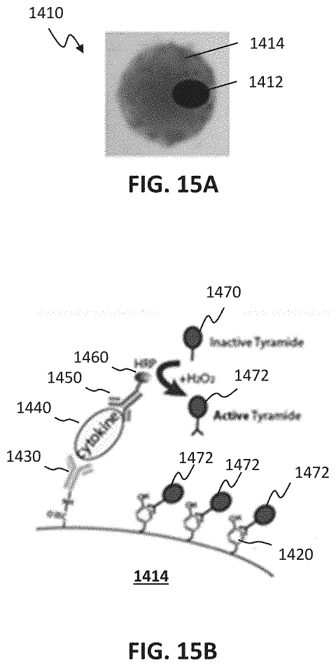

The marker particle (and/or one or more bodies forming part of the marker particle) may have any suitable distinctive form (e.g., size, shape, material, and/or number of bodies, etc.) observable through shadow imaging to identify the marker particle type. FIGS. 16A-16J are schematic illustrations of shadow identifiers. For example, a marker particle may be any suitable shape, such as spherical (FIGS. 16B and 16C), oblate (FIGS. 16D and 16E), or polygonal or block-shaped (e.g., “L”-shaped as shown in FIG. 16F). Furthermore, one or more bodies (e.g., body 1612) may have any suitable shape, such as spherical (FIG. 16B and FIG. 16C), diamond (FIG. 16D), or polygonal or block-shaped (e.g., “L”-shaped as shown in FIG. 16F). Sizes of the one or more bodies 1612 and/or overall marker particle may also vary (e.g., body 1612 is smaller in FIG. 16B than in FIG. 16C).

In variations in which the form of a marker particle includes one or more bodies 1612 and capture material 1614, a body 1612 may be generally centered within the capture material 1614 (FIG. 16B, FIG. 16D) or off-center within the capture material 1614 (FIG. 16C). Furthermore, in some variations the capture material 1614 may be a conformal coating whose form generally corresponds to the form of an internal body 1612 (FIGS. 16B and 16F).

A marker particle may include any suitable compound number of bodies, such as two bodies (FIGS. 16G and 16H), three bodies (FIG. 16I), or more. Furthermore, two or more of these characteristics can be combined to form other distinctive shadow identifiers. For example, while both marker particles of FIGS. 16G and 16H have a shadow identifier including two bodies, the marker particle shown in FIG. 16G has two smaller sized bodies while the marker particle shown in FIG. 16H is distinct from the marker particle shown in FIG. 16G by having one smaller sized body and one larger sized body.

Furthermore, in some variations, a marker particle may include zero bodies 1612. For example, as shown in the schematic of FIG. 16A, a marker particle may omit bodies 1612 such that its shadow identifier is based at least in part on the absence of an opaque or semi-opaque material. In other words, the shadow of a marker particle without bodies 1612 (which may be appear as a substantially empty entity, for example) may be distinguished from the shadow of a marker particle with one or more bodies 1612 (which may appear as an entity including an opaque or semi-opaque mass). Thus, the absence of another body within the capture surface material 1414 may be a unique identifying characteristic of the marker particle. Additionally or alternatively, as shown in the FIG. 16J, a marker particle may omit bodies 1612 but include capture material 1614 that is formed in a distinct shape, such that its shadow identifier is based at least in part on the form of the capture material 1614.

In some variations, a marker particle is made by forming a capture material (e.g., around one or more internal bodies, and/or into a form providing a basis for a shadow identifier) and attaching one or more antibodies or other capture features. The capture material 1414 may be, for example, a conformal coating or a layer of material otherwise applied around the one or more bodies 1412, thereby forming an external capture surface. The capture material 1414 generally include, for example, a solid material or a suitable non-Newtonian fluid (e.g., slime-like and amorphous). For example, the capture surface may include a layer of gelatin, hydrogel (e.g., polyacrylamide), latex, polystyrene, a metal surface (e.g., gold or palladium), a polymer surface, PEG that can bind proteins, other hydroscopic materials that can bind proteins or biotin, avadin, strepavadin, Protein A, Protein G, or combinations thereof, etc. As another example, the capture surface may include a silica or metal oxide (e.g., alumina, titania, etc.), polystyrene, melamine, polylactide, or similar surface modified with a suitable silane (e.g., carboxylates, amin terminus, polyhistidine-tag terminus, etc.). As yet another example, the capture surface may include one or more dextran-based materials that can be cross-linked to varying extents and/or embedded with nano- or microparticles.

In some variations, the capture surface may include any suitable surface for allowing attachment or anchoring of one or more antibodies to the capture surface. One or more capture antibodies may be attached to the capture surface in any suitable manner, including transglutaminase (“meat glue”), amide bonds (e.g., via organic or inorganic reagents), biotin, protein A, protein B, or non-specific binding (adsorption) interactions, etc. Additionally, other capture features (e.g., specific to an analyte or cell of interest) such as sidechains may be similarly attached to the capture surface. Antibodies may, for example, be attached to a solid surface using any suitable method, such as with coupling reagents such as EDAC for plastic surfaces, or attached to other surfaces (e.g., hydrogel surfaces) through enzymatic coupling such as glutarase.

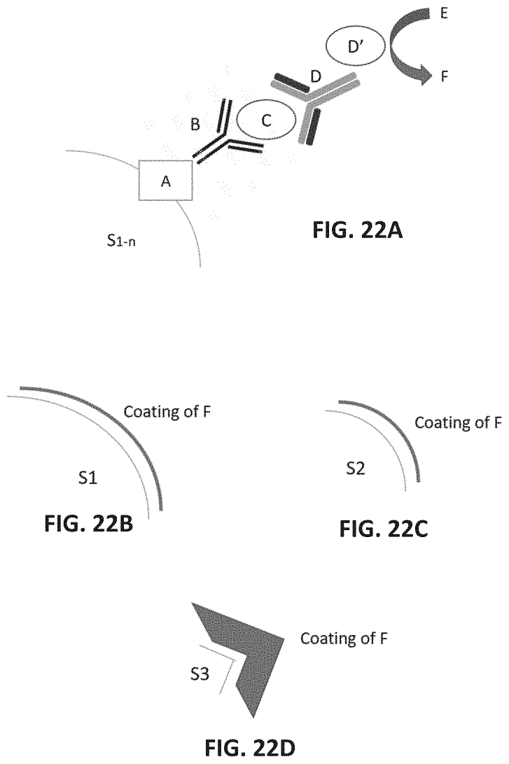

An exemplary illustrative schematic of a darkening scheme for a marker particle is shown in FIG. 22A. Specifically, FIG. 22A illustrates a marker particle having a capture surface (S₁₋ₙ) of suitable size and shape. As shown in FIGS. 22B-22D, the capture surface may vary in size (e.g., surface 51 in FIG. 22B is generally larger in area than surface S2 in FIG. 22C) and/or shape (e.g., surfaces 51 and S2 in FIGS. 22B and 22C are generally curved or spherical, while surface S3 in FIG. 22D is angled or square). One or more capture antibodies (B) may be attached to the capture surface as described above. At least one feature of interest (e.g., analyte or cell) (C) may be bound between a capture antibody (B) and an enzyme-conjugated detection antibody (D) may be coupled to a detection catalyst (D′). The detection antibody (D) may be conjugated with any suitable enzyme such as HRP, AP, Tyramide, Beta Galactosidase, etc. For example, in an illustrative variation, human IL-2 may be bound between a mouse anti-human IL-2 capture antibody and a rabbit-anti human IL-2 coupled to HRP.

When mixed with a detection substrate (E) (e.g., probe having an enzyme substrate such as XGAL or BLUE-Gal (and variants for Beta Galactosidase), Tyramide, phosphates, etc.), the enzyme substrate may be consumed by the enzyme on the detection antibody (D), which results in a darkening substance such as precipitate or film (F) in or on the marker particle's capture surface. For example, the darkening substance may be concentrated within a pore of the capture surface and/or adsorb to the pore's surface. This may cause a change in color on the capture surface (e.g., in the capture material), which may be perceived or imaged by a shadow imager as a change in darkness (darkness shift). For example, in an illustrative variation, Beta Galactosidase may act upon XGAL or Blue-Gal and catalyze the formation of a precipitate that is detectable in or around the capture surface and causes the marker particle to experience a darkness shift. As shown in FIGS. 22B-22D, the size and/or shape of the region (e.g., large or small, curved or angled) undergoing the darkness shift may correspond to the size and/or shape of the capture surface which is distinctive, thereby allowing identification of the marker particle associated with present feature of interest. In other words, while specificity of an assay is based on specificity of capture and/or detection antibodies such as that described above, the multiplexing functionality of the assay is based on the size and/or shape of a darkened region of marker particles as imaged. The capture surface on the marker particle may be porous, which may help increase the darkening effect or darkness shift. In some variations, the capture surface may include pores (e.g., between about 2 nm to about 5 nm in diameter, or up to about 100 nm or more. For example, increased porosity (e.g., increased size of pores, increased number of pores, etc.) may allow enzymes to penetrate more deeply into pores of the capture surface and/or allow antibodies to be attached to the capture surface. Other properties that may be varied are antibody titer and/or capture surface area, which define the number of active sites and can be used to improve the quantity of capture antibody. Higher amounts of these biomolecules in or attached to the capture surface, when used with an analyte and a detection antibody and detection reagents, may enhance the darkness shift, thereby increasing the ability to detect (e.g., in a shadow image) the darkness shift and determine presence of one or more analytes responsible for triggering the darkness shift.

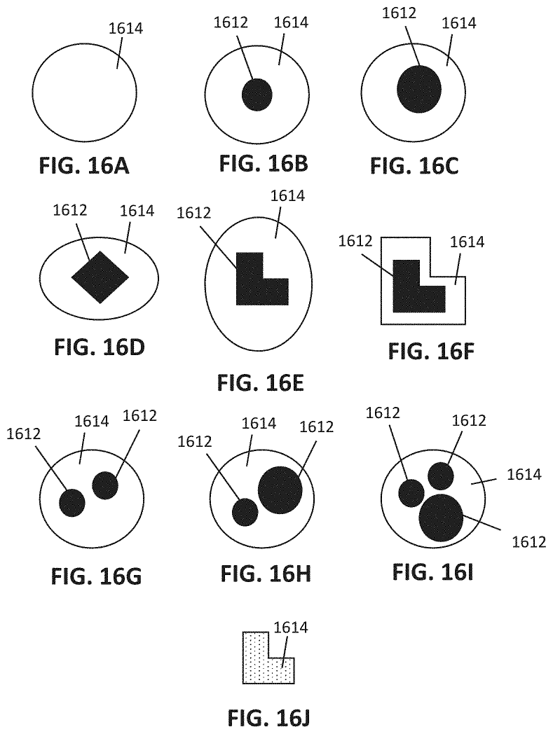

As shown in FIG. 17A, another method 1700 of making a marker particle utilizes semiconductor manufacturing or photolithographic techniques, including applying a sacrificial layer on a substrate 1710, patterning marker bodies on the sacrificial layer 1720, isolating the marker bodies 1730, applying capture material onto the marker bodies 1740, and applying one or more capture features onto the capture material 1742. For example, applying a sacrificial layer on a substrate 1710 may include applying a layer of photoresist (e.g., SU-8, or related polymer coatings) on a silicon wafer substrate through a spin-coating process, which spreads a sacrificial layer of photoresist (e.g., metal) that is substantially uniform. The spin-coating may, for example, be about 5 μm thick across the wafer. Patterning the marker particles 1720 may include forming marker bodies on the sacrificial layer through a suitable lithographic lift-off process, which selectively removes parts of the sacrificial layer to create characteristic shapes and/or sizes to function as shadow identifiers for the patterned marker bodies. That is, in some variations, some parts of the sacrificial layer may be removed (e.g., with acetone) and some parts will remain to become marker bodies. For example, as shown in FIG. 17B, a repeating pattern of marker bodies 1750 (to become internal bodies of marker particles) may be formed on a wafer through the above-described process. Generally, in some variations, the marker bodies may be formed on approximately a 100 μm-level scale. The patterned marker bodies may be isolated and removed as individual bodies, such as by agitating or rinsing the patterned wafer in acetone to dissolve bonds and remove the marker bodies off the wafer. Finally, capture material (e.g., gelatin, hydrogel, etc. as described above) may be applied onto the isolated marker bodies through an agglomeration or other suitable process. For example, capture material may be applied as a conformal coat around the isolated bodies, thereby embedding the bodies in the capture material and creating an external capture surface. Additional capture features (e.g., antibodies) may be attached to the capture surface with transglutaminase, amid bonds, other binding, etc. as described above. As shown schematically in FIG. 17C, the resulting marker particles are similar to the marker particle 1760, which includes an internal body 1762 and a coating of capture material 1764, where marker particle 1760 has a shadow identifier based on the cross-like shape of the internal body and/or the capture surface.

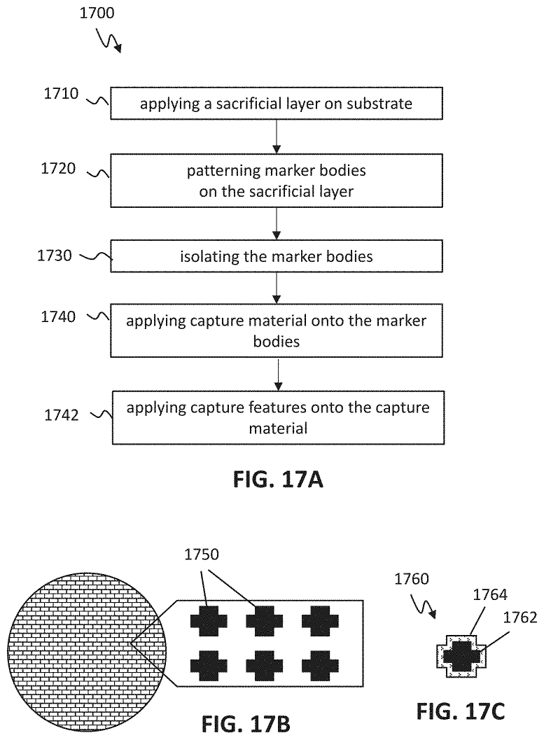

FIG. 18 illustrates another variation of a method 1800 of making a marker particle with photolithographic techniques, including applying a sacrificial layer of capture material on a substrate 1810, patterning marker particles on the sacrificial layer 1820, isolating marker particles 1840, and applying one or more capture features onto the capture material 1842. Similar to method 1700, a sacrificial layer of material may be spin-coated onto a wafer substrate. However, in method 1800, the sacrificial layer is capture material such as pig collagen gel, such that the subsequent patterning step forms marker particle shapes out of the capture material. That is, in some variations, some parts of the pig collagen gel may be removed, and some parts will remain to become marker particles. For example, as shown in FIG. 18B, a repeating pattern of marker particles 1850 may be formed on a wafer through the above-described process, and the capture material may be in a shape defined by the lithographic step. The marker particles may be isolated, and additional capture features (e.g., antibodies) may be attached to the capture surface of the isolated marker particles, in processes similar to that described above with respect to method 1700. As shown schematically in FIG. 18C, the resulting marker particles may have a shadow identifier based on the cross-like shape of the capture material 1864.

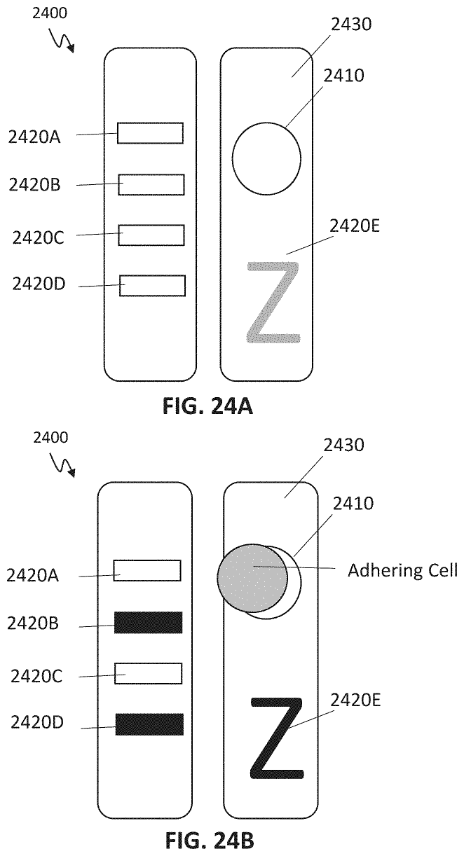

FIGS. 24A and 24B illustrate another exemplary variation of a marker particle 2400 having multiple marker regions 2420A-2420E on a marker body 2430, each of which is specific to a different respective feature of interest (e.g., analyte such as an antibody or other protein). For example, a first marker region 2420A may be specific to a first feature of interest, a second marker region 2420B may be specific to a second feature of interest, a third marker 2420C may be specific to a third feature of interest, a fourth marker 2420D may be specific to a fourth feature of interest, and a fifth marker 2420E may be specific to a fifth feature of interest. The first, second, third, fourth, and fifth features of interest may be unique (different from one another). Marker particle 2400 may also include a cell anchor region 2410 having capture antibodies (similar to the capture surfaces described above) specific to an entity of interest such as a cell.

Marker regions may be distributed around the surface of the marker body 2430. For example, FIG. 24A illustrates two different faces (e.g., front side and back side) of the marker body 2430. One or more marker regions may have a distinctive size and/or shape (e.g., similar to shadow identifiers as described above) which may allow identification of the feature of interest (e.g., analyte) that is responsible for any darkness shift of the capture region. Additionally or alternatively, one or more marker regions may be identifiable based on its position or relative location on the marker particle body 2430. For example, marker regions 2420A-2420D are generally linear or rectangular, while capture region 2420E is a “Z”-shape. It should be understood that any suitable number (e.g., two, three, four, five, six, or more) of marker regions may be arranged in any suitable manner (e.g., linear, in a grid-like array, radial array, random, etc.). In some variations, the marker regions may dimensionally be about on the scale of between about 0.5 μm and about 20 μm, for example, but may be any suitable dimension.

The cell anchor region 2410 may also be arranged on the marker body 2430, such as near marker regions. The cell anchor region 2410 may be, for example, between about 0.5 μm and about 30 μm, or any suitable dimension. Although the cell anchor region 2410 is depicted in FIG. 24A as generally circular, it should be understood that the cell anchor region 2410 may have any suitable shape (e.g., rectangular, square, oval, etc.). The marker particle, its capture regions, and the cell anchor region may be made, for example, with materials similar to that described above for other variations of marker particles and capture surfaces.

Based on similar enzyme-mediated processes described above for enzyme-linked darkening assays, a single marker particle 2400 may be used to simultaneously indicate presence of multiple features of interest (e.g., analytes), by virtue of a darkness shift of one or more of the marker regions 2420. For example, when the marker particle 2400 is mixed with a sample containing cells, a cell specific to the cell anchor region 2410 (e.g., a CD45+ leukocyte specific to a cell anchor region having anti-CD45 capture antibodies) may bind to the cell anchor region 2410. Upon binding, the captured cell may experience a detectable darkness shift that indicates the presence of the CD45+ cell. Additionally or alternatively, the presence in the sample of an analyte (e.g., IgG) that is specific to a fifth marker region 2420E may cause the marker region 2420E to experience a detectable darkness shift that indicates the presence of that analyte. One or more of the marker regions 2420A-2420D may similar experience a darkness shift in the presence of their respective analytes of interest. For example, as shown in the post-sample exposure schematic of FIG. 24B, the second marker region 2420B, the fourth marker region 2420D, and the fifth marker region 2420E are the only marker regions to have undergone a darkness shift. Thus, based on the darkened pattern of FIG. 24B, the second, fourth, and fifth analytes of interest (specific to these marker regions) may be present while it may be determined that the first and third analytes of interest (specific to the undarkened marker regions) are not present in the sample.

Thus, the darkening pattern may also be considered a “barcode” to simultaneously suggest multiple or overall POD content characteristics. In some variations, this “barcode” may further be used to uniquely identify a POD in which the marker particle 2400 resides, such as for subsequent detection, tracking, sorting purposes, etc. It should be understood that the schematics of FIGS. 24A and 24B are illustrative only, and various other scenarios of darkening are possible depending on the application.

### EXAMPLES

Generally, any of the above-described marker particles may be configured to experience a darkness shift in the presence of one or more analytes of interest in a sample, and thus indicate presence of the one or more analytes of interest. For example, a sample with features (e.g., analytes (cytokines, hybridomas, and the like), cells, etc.) of interest may be combined with marker particles capable of experiencing darkness shift, then passed into a chamber. The sample in the chamber may be imaged with an imager array located generally opposite the light source so as to obtain a shadow image of the sample, where the image may depict one or more marker particle types. One or more features of interest in the sample may be identified (and further analyzed for other attributes) based at least in part on the form of the darkness-shifted marker particles as depicted in the sample image. Each marker particle type undergoing a darkness shift may be identified by virtue of a unique shadow “barcode” or shadow identifier corresponding to the form of the changed marker particles. Multiple shadow identifiers may be used in parallel to enable multiplexed analysis of multiple features of interest.

Generally, enzyme-linked darkening assays as described herein may be used in diagnostic or other applications in which multiple analytes in a panel are desired to be detected. One such panel may include, for example, Thrombin, B2M, and/or other biomarkers. Other exemplary panels may include human IFNs and related pro-inflammatory cytokines such as IFN Alpha (IFN-α), IFN Beta (IFN-β), IFN Gamma (IFN-γ), IFN Omega (IFN-w) and IFN Lambda (IFN-λ, 1, 2 and 3), human interleukin 1 Alpha (IL-1α), Human Interleukin-6 (IL-6), Human IFN Gamma inducing protein-10 (IP-10) and Human Tumor Necrosis Factor-Alpha (TNF-α), or any combination thereof. As another example, generally, enzyme-linked darkening assays as described herein may be used in research or other applications in which simultaneous cytokines are desired to be detected. For example, cellular or cancer research may benefit from simultaneous detection of the concentrations of IL-2, IL-4, IL-15, and TNF-α.

### Example 1

FIGS. 14A-15B illustrate an exemplary use of marker particles with darkness shift. As described above and shown in FIG. 14A, a marker particle 1410 may include a body 1412 (e.g., bead) and a capture material 1414 including a capture surface. FIG. 14B illustrates an enzyme scheme on the capture surface utilizing an enzyme-linked darkening assay technique. Specifically, FIG. 14B illustrates a marker particle that may experience a darkness shift via a “sandwich” arrangement. In this sandwich arrangement, an analyte of interest 1440 is bound between two antibodies, including a capture antibody 1430 and an enzyme-conjugated detection antibody 1450. When mixed with a suitable detection catalyst and a probe 1470 having an enzyme substrate (detection substrate), the enzyme substrate is consumed by the enzyme on the primary antibody 1450, which results in darkening precipitation in or on the marker particle's capture surface. This precipitation causes a change in color on the capture surface (e.g., in the capture material 1414), which may be perceived or imaged by a shadow imager as a change in darkness (darkness shift).

In the example of FIG. 14B enabling cytokine detection cytokine is bound between a primary capture antibody 1430 attached to the marker particle, and a primary antibody 1450 conjugated with horseradish peroxidase (HRP). The marker particle may be mixed with a probe such as a bead having inactive tyramide 1470 as an enzyme substrate. In the presence of hydrogen peroxide (H₂O₂), HRP catalyses the formation of active tyramide 1472 from the inactive tyramide 1470. As shown in FIG. 15B, the active tyramide 1472 may then bind to capture features 1420 such as tyrosine sidechains attached to the marker particle surface. Accordingly, the bound tyramide 1472 causes an observable change to the marker particle (color, size, etc.) that may be detected in a shadow image. For example, as shown in FIG. 15A, the above-described enzyme-mediated reaction may cause the marker particle 1410 to change color, which appears as a darkness shift in a shadow image.

Generally, the darkness shift is an increase in darkness due to increased blocking of light before the light sensor in the shadow imager. Accordingly, the detected darkness shift, which requires the presence of the analyte of interest to occur, may indicate the presence of the analyte of interest. Thus, when using marker particles with darkness shift, analysis of analytes depends on detection of darkness shift, rather than detection of fluorescence as with conventional enzyme amplification schemes. Various kinds of analysis (e.g., analyte concentration) may be performed based on, for example, the number of marker particles detected to experience a darkness shift.

### Example 2

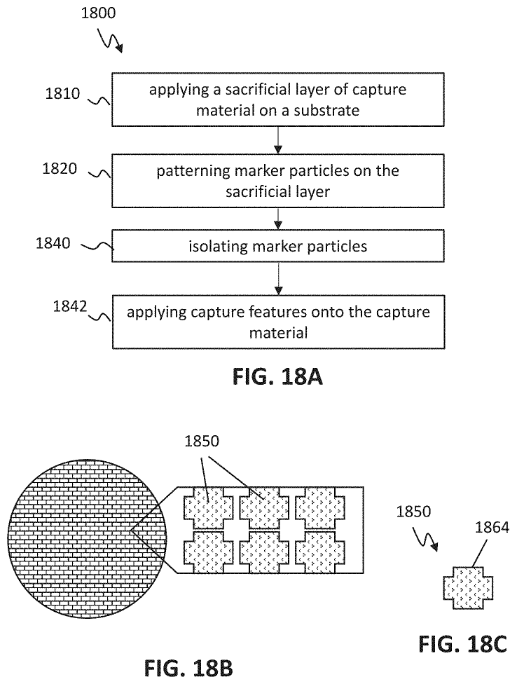

Furthermore, as described above, detection of different kinds of marker particles (distinguished based on different forms, for example) experiencing a darkness shift may facilitate the analysis of different analytes of interest associated with the marker particles, in multiplexed fashion. For example, FIG. 19 illustrates a multiplexing application of darkness-shifting marker particles using three different marker particle types. Specifically, FIG. 19 illustrates a size-based multiplexing application of darkness-shifting marker particles. A first marker particle type A includes a first spherical bead having a size of about 10 μm, a second marker particle type B includes a second spherical bead having a size of about 15 μm, and a third marker particle type C includes a third spherical bead having a size of about 20 μm. An agglomeration process is used to coat the beads with a hydrogel. Capture antibodies are attached to the marker particles in a transglutaminase wash. Specifically, in the example of FIG. 19, a first capture antibody type (monoclonal antibody mAb1) is attached to the first marker particle type A, a second capture antibody type (monoclonal antibody mAb2) is attached to the second marker particle type B, and a third capture antibody type (monoclonal antibody mAb3) is attached to the third marker particle type B. Thus, the three marker particle types include different forms (different sizes) to be distinguishable from one another in a shadow image, and each marker particle type is coated with a different antibody type. The marker particles are mixed with analytes to form a sample for analysis. For example, the sample may be manipulated to form PODS. The PODS may be passed into a vessel (e.g., Eppendorf tube) for further processing, including mixing with an enzyme-conjugated antibody such as a polyclonal antibody conjugated with alkaline phosphatase (pAb-AP). An enzyme reaction is initiated with introduction of a 5-bromo-4-chloro-3-indolyl phosphate (BCIP) and nitro blue tetrazolium (NBT) substrate, and results in a blue-purple product that colors the affected marker particles. This reaction may be terminated by introducing a quenching reagent such as EDTA. Following this processing, the PODS may be passed into an assay system with a chamber arrangement with an optical shadow imaging arrangement, such as that described above. As shown in FIG. 19, the shadow imaging arrangement may capture images of marker particles, some of which may have changed colors (experienced a darkness shift) if their respective analytes of interest were present in the sample. For example, presence of mAb1 would induce a darkness shift in marker particles of type A, and would be measurable based on detection of darkened marker particles with 10 μm beads. Presence of mAb2 would induce a darkness shift in marker particles of type B, and would be measurable based on detection of darkened marker particles with 15 μm beads. Presence of mAb2 would develop a darkness shift in marker particles of type C, and would be measurable based on detection of darkened marker particles with 20 μm beads. Accordingly, simultaneous detection of multiple darkened marker particle types may facilitate an efficient, high throughput assay with the use of enzymatic amplification and multiplexing.

### Example 3

Another example of a size-based multiplexing application involves the use of monodisperse hydrogels of different sizes. Example 3 may be similar to Example 2 above, except that a first marker particle type A may include a hydrogel sphere of a first size (e.g., 5 μm), a second marker particle type B may include a hydrogel sphere of a second size (e.g., 10 μm), and a third marker particle type C may include a hydrogel sphere of a third size (e.g., 15 μm). Like in Example 2, the marker particles darken when developed with their associated analyte and enzyme reaction (e.g., in sandwich ELISA). However, instead of distinguishing between the marker particle types based on size of internal beads, in this example the marker particle types may be distinguished based on overall marker particle size.

### Example 4

An example of another form-based, enzyme-linked darkness assay multiplexing application involves the use of marker particles each having different sizes and/or numbers of beads. Example 4 may be similar to Example 2 above, except that each marker particle type may include a different respective bead shape (or have a respective marker particle shape) and/or different respective number of beads. For example, a first marker particle type A may be any of the marker particle examples shown in FIGS. 16A-16J (or another variation thereof), a second marker particle type B may be a different, second example shown in FIGS. 16A-16J (or another variation thereof), and a third marker particle type C may be a different, third example shown in FIGS. 16A-16J (or another variation thereof). Like in Example 2, the marker particles darken when developed with their associated analyte and enzyme reaction. However, instead of distinguishing between marker particle types based only on size of internal beads, in this example the marker particle types may be distinguished based on other form features, including shape and/or number of internal beads.

### Example 5

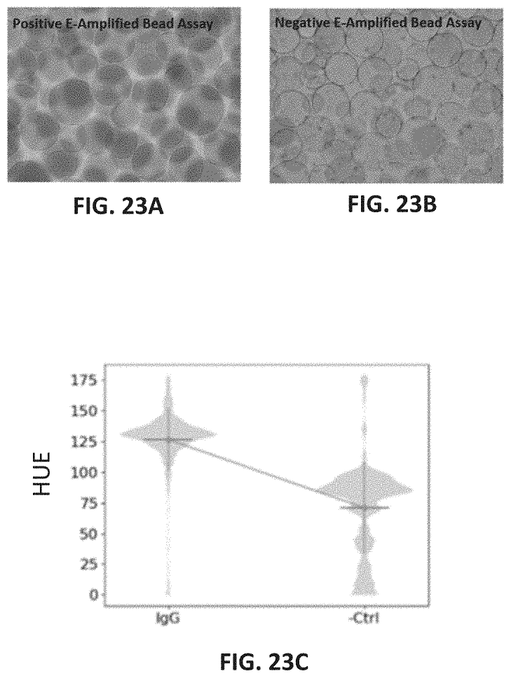

An example of an enzyme-linked darkness assay includes the use of hydrogel beads having capture surfaces with anti-IgG antibodies, such that the hydrogel beads are specific to IgG in a sample. A sample including IgG was combined with such hydrogel beads and a darkening reagent, and dispersed into experimental PODS that were passed into an assay system such as that described above. FIG. 23A depicts an illustrative shadow image of these experimental PODS, in which a darkness shift in the PODS is apparent. Additionally, a control sample without IgG was similarly combined with the above-described hydrogel beads and a darkening reagent, and dispersed into control PODS that were passed into an assay system such as that described above. FIG. 23B depicts an illustrative shadow image of these control PODS, in which no darkness shift in the PODS is apparent. A visual comparison of the darkened experimental PODS in FIG. 23A and non-darkened control PODS in FIG. 23B suggests that the presence of IgG in the experimental PODS may be identified by analyzing the shadow image(s) of the experimental PODS. FIG. 23C, which depicts violin plots of the hues (represented quantitatively as a singular number corresponding to an angular position around a color wheel) of imaged PODS in the experimental (“IgG”) and control (“Ctrl”) samples. As shown in FIG. 23C, the mean hue of experimental IgG PODS is higher (darker) than the mean hue of control PODS. Additionally, the overall hue distribution for the experimental PODS is narrower than that for the control PODS, suggesting that the darkening shift occurring within the experimental PODS is consistent among experimental PODS containing the same IgG concentration, which is further suggestive of reproducibility of the enzyme-linked darkness assay.

### Wavelength Detection Windows

In some variations, as described in further detail below, a method for processing a sample in a multiplexed manner may utilize inherent wavelength detection cutoffs of a filterless imager array.

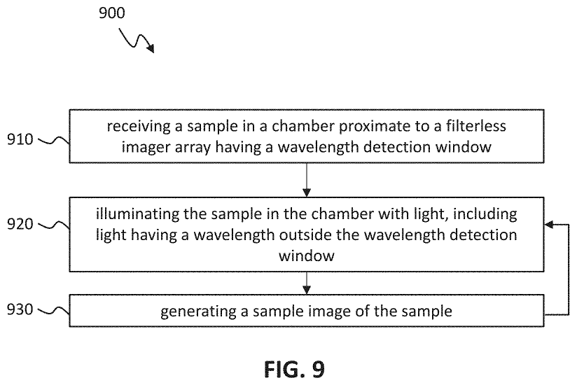

FIG. 9 is an illustrative schematic of another variation of a method 900 for processing a sample. As shown in FIG. 9, method 900 may include receiving a sample in a chamber 910 proximate to a filterless imager array having a wavelength detection window, illuminating the sample in the chamber 920 with light, wherein the light includes light having a wavelength outside the wavelength detection window, and generating a sample image of the sample 930. Illumination of the sample with light may induce at least a portion of the sample to fluoresce light within the wavelength detection window.

In some variations, the method 900 may be used with a chamber similar to that described above with respect to FIGS. 3A and 3B and does not include a filter for the imager array. In some variations, the chamber arrangement may operate such that different fluorescent characteristics of sample (e.g., different analytes exhibiting different fluorescence characteristics) can be distinguished even in the absence of filters (which add to cost, weight, complexity of manufacturing, etc. as described above). Accordingly, multiple analytes in a sample can advantageously be identified and analyzed in parallel in a single device.

Generally, due to material properties, construction, and other inherent aspects of image sensors (e.g., CMOS transistors), image sensors may inherently be limited to detecting only certain wavelengths of light, independent of any external coupled filters. In other words, inherent properties of image sensor may restrict an imager array to generate images based on detection of light having wavelengths falling within a certain range of wavelengths, or a wavelength detection window. In some variations, the wavelength detection window is bound at a lower level at a wavelength of about 350 nm. In other words, some variations of image sensors may be unable to detect light having wavelengths before 350 nm.

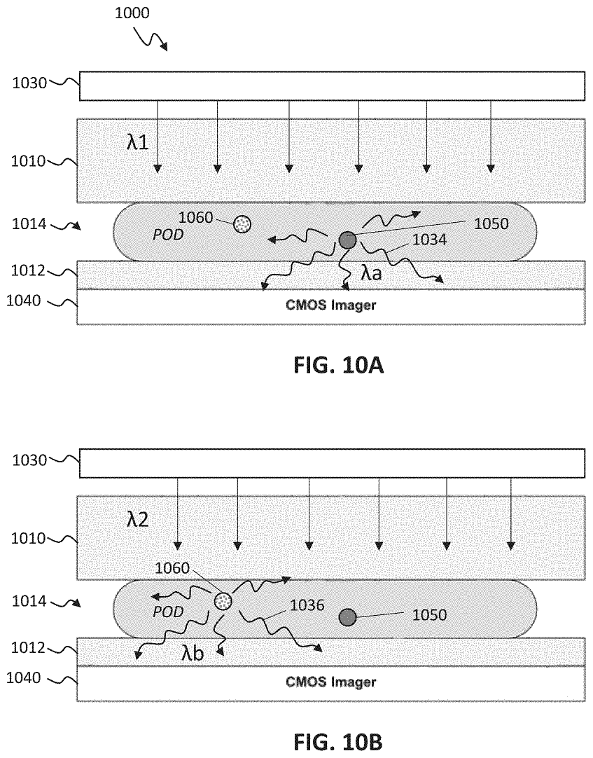

The method 900 may leverage the wavelength detection window to enable fluorescent imaging without external filters. For example, as shown in FIGS. 10A and 10B, a chamber arrangement 1000 may include a chamber having an upper surface 1010 and a lower surface 1012 that define a gap or chamber volume 1014 for receiving a sample. The chamber arrangement 1000 may include a filterless imager array 1040 configured to image the flow of the sample in the chamber, where the imager array has a wavelength detection window or other threshold (e.g., λ_{cutoff}). One or more light sources in a light source array 1030 may be configured to emit light of a plurality of different wavelengths, such that different wavelengths of light can illuminate the sample in the chamber. For example, the light source array 1030 may include multiple LEDs each configured to emit monochromatic light of a respective wavelength. As shown in FIG. 10A, the light source array 1030 may be configured to illuminate the sample with light having a first wavelength λ1, which may be outside the wavelength detection window (e.g., below λ_{cutoff}) such that the imager array 1040 is unable to detect it. However, at least a portion of the sample (e.g., particle 1050 of potential interest, which may be an analyte, marker particle, etc.) may be configured to absorb light at the first wavelength λ1 and be induced to fluoresce light 1034 of a different wavelength λa that is within the wavelength detection window of the imager array 1040 (e.g., above λ_{cutoff}). Accordingly, at the time of fluorescence emission, the imager array may generate an image based only on detection of the light at wavelength λa, as the imager array is “blind” and unable to detect the light at wavelength λ1 emitted by the light source array 1030. Thus, the resulting fluorescence image is the result of substantially only light emitted by the particle 1050 of potential interest, and is acquired without the use of external filters.

Similarly, as shown in FIG. 10B, the light source array 1030 may be configured to illuminate the sample in the chamber with light having a second wavelength λ2, which may also be outside the wavelength detection window such that the imager array 1040 is unable to detect it. The second wavelength λ2 can be different from the first wavelength λ1, such that a different portion of the sample (if any) fluoresces in response to the light at second wavelength λ2. Specifically, as shown in FIG. 10B, a second portion of the sample (e.g., second particle 1060 of potential interest, such as an analyte, marker particle, etc.) may be configured to absorb light at the second wavelength λ2 and be induced to fluoresce light 1034 of a different wavelength λb that is within the wavelength detection window of the imager array 1040 (e.g., above λ_{cutoff}). Accordingly, at the time of fluorescence emission, the imager array may generate an image based only on detection of the light at wavelength λb, as the imager array is “blind” and unable to detect the light at wavelength λ2 emitted by the light source array 1030. Thus, the resulting fluorescence image is the result of substantially only light emitted by the particle 1060 of potential interest, without the use of external filters.

Moreover, coordinated illumination at different wavelengths and fluorescent imaging may enable multiplexed processing of multiple analytes in a sample in a single chamber arrangement. For example, the sample may be illuminated with light having a first wavelength and with light having a second wavelength, and/or with light at additional wavelengths according to a predetermined sequence (e.g., serially). The plurality of different wavelengths may be separated or spaced apart by any suitable distance, though in an exemplary variation the plurality of different wavelengths are separated by at least about 50 nm. Different analytes may fluoresce in response to absorbing different wavelengths of illumination light. One or more respective fluorescence images associated with the illumination of each wavelength can thus be generated in order to capture the overall fluorescence response of the sample to each of the plurality of wavelengths of light emitted by the light source array 1030. For example, in a stream of sample images generated while different light sources sequentially illuminate the sample, a first set of frames (e.g., one, two, three, or more frames) may be correlated to illumination at a first wavelength in order to capture the sample's fluorescence response, if any, to such first wavelength of light. Similarly, a second set of frames may be correlated to illumination at a second wavelength in order to capture the sample's fluorescence response, if any, to such second wavelength of light, and so on for additional wavelengths of light illuminating the sample.

The overall fluorescence response, as captured by multiple images of the sample in the chamber, can be subsequently be analyzed to identify and characterize multiple analytes or other aspects of the sample that may be of interest. For example, intensity of the sample's fluorescence response to a particular wavelength of illumination can be correlated to analyte concentration. Additionally or alternatively, in some variations the analysis of the sample may be based on a machine learning model (e.g., neural network) that is based on training data, where the machine learning model may take fluorescence information as an input and output analyte concentration and/or other sample information.

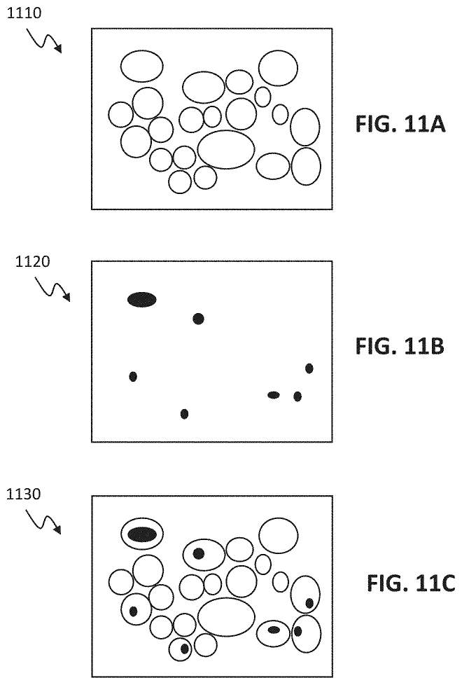

In some variations, multiple images may be overlaid to enable visualization of the entire sample. For example, FIG. 11A is a schematic illustration of a first image 1110 of a sample taken in response to illumination at a first wavelength. The first image 1110 might capture only a portion of the sample, such as POD outlines. FIG. 11B is a schematic illustration of a second image 1120 of a sample taken in response to illumination at a second wavelength. The second image 1120 might capture only another portion of the sample, such as fluorescent light emitted by an analyte (which might be present in only some of the PODS). Individually, the first and second images 1110 may not provide a comprehensive picture of the entirety of the sample. However, when combined and overlaid (and/or when combined or overlaid with additional images similarly providing only a partial visualization of the sample), the combined image 1130 as shown in FIG. 11C may enable visualization of the entire sample imaged at multiple spectrums. The separate images corresponding to different wavelengths of detected light can be aligned (e.g., with the use of fiducials) to form such a combined image.

Generally, to facilitate overlaying of multiple images as described above, the separate images may be generated faster than the speed of the sample flow in the chamber. For example, in some variations, the frequency at which images are taken (and/or the rate at which the wavelength of light emitted by the light source array changes) can be at least about 100 times faster than the refresh rate of the sample (e.g., the rate at which a complete new set of PODS enters the field of view of the imager array). As an illustrative example, if a new set of PODS or sample volume passes through the imaged portion of the chamber once every second (i.e., sample refresh rate is about 1 Hz), then at least 100 images may be taken every second.

### Cell Detection

Additionally or alternatively, a method for processing a sample may include detecting one or more cells in the sample. In some variations, a dye (e.g., Trypan blue) may be introduced into a sample such that the dye may enter any cells that are present in the sample. The dye may be used to distinguish between live cells and dead cells. For example, pores in the surface of dead cells tend to be more dilated, which enables a greater amount of dye to enter the cell and cause a greater darkening shift (e.g., greater opacity) of the cell, compared to a live cell. Thus, when live cells and/or dead cells are mixed with a dye and then introduced into an optical imaging chamber such as that described herein, dead cells may appear darker or more opaque than live cells. Accordingly, the darkness shift of the cells may be used to distinguish between dead cells and live cells, and subsequently dead cells and/or live cells may be quantified for subsequent analysis.

As another example, cells may be covered by marker particles (e.g., anti-CD45 beads or other suitable marker particles) depending on the specific protein expression the cell surface. When mixed with marker particles specific to a cell surface expression of interest, cells having that cell surface expression of interest may be covered or captured by such marker particles, which increases their visible footprint area (making the cell appear larger) and/or opacity or darkness of the cell-marker complex, relative to the cell alone. Thus, size and/or darkness shift of a cell may be used to identify cells having surface proteins of interest.

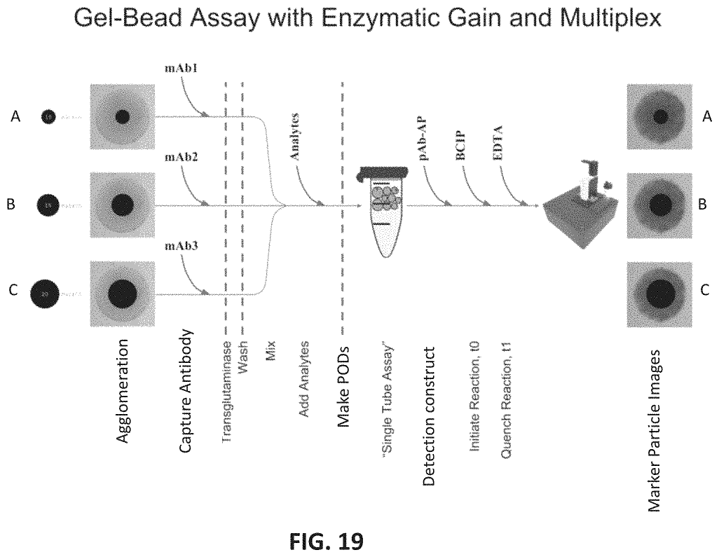

In another example, cells may be captured or tagged by marker particles including beads or other particles including nanoparticles of specific materials that allow the marker particles to be distinguished due to observed optical phenomena. When viewed by optical imaging systems such as those described above, nanoparticles of certain different materials appear as differently-sized opaque spots, even if the different material nanoparticles are the same physical size. For example, a 100 nm Au particle may appear to be a first size in a shadow image (e.g., 2 μm diameter black spot), a 100 nm Ni particle may appear to be a second size in a shadow image (e.g., 1.5 μm diameter black spot), and a 100 nm Fe particle may appear to be a third size in a shadow image (e.g., 1 μm diameter black spot). Thus, in an example to leverage this optical phenomenon, as shown in FIG. 20, a marker particle (e.g., bead) may include a cross-linked polymer, with antibodies and metal nanoparticles attached (or embedded, such as if the marker particle is porous). For example, such a marker particle may include Dextran cross-linked polymer and nanoparticles may be joined at approximately a 100 nm scale. In this example, these marker particles would allow cells that bind to the marker particles' antibodies to be visualized and discriminated based at least in part on the size of the black, opaque spots (corresponding to different nanoparticle materials).

### Cell Secretion

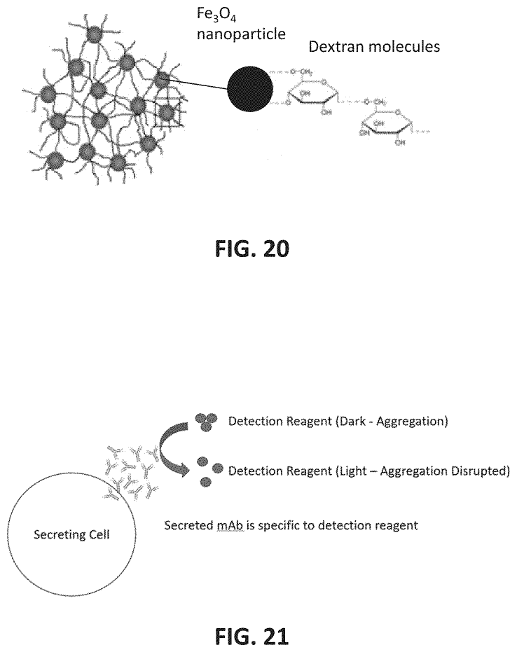

Additionally or alternatively, a method for processing a sample may include detecting one or more cell secretions in a sample (or the cells themselves). For example, generally, in a cell secretion assay, one or multiple analytes (e.g., a protein of interest such as a cytokine or a monoclonal antibody (mAb)) may be secreted by one or more cells, and it may be desirable to determine which analyte(s) are secreted. With reference to FIG. 21, a sample including secreting cells and at least one detection reagent may be dispersed into PODS and passed through an assay system as described above to produce shadow images of the PODS. The one or more analytes of interest that are secreted from the cells may be specific to a detection reagent, such that the resulting aggregation results in a darkened, shadowed mass that is detectable in the shadow image. Thus, identification of an aggregated mass in a POD may indicate that one or more analytes of interest has been secreted from the cells. Multiple analytes (e.g., specific to different reagents mixed with the sample) may furthermore be identifiable in parallel using the assay system.

In some variations, multiple variations of methods for processing a sample may be combined. For example, a chamber arrangement may be configured for both optical shadow imaging and fluorescent imaging, and may be used in conjunction with both method 400 (leveraging multiple sizes of marker particles) and method 900 (leveraging selective illumination to induce fluorescence) as described above. Such combinations can be used for multiplexed analysis of multiple analytes in a sample, and/or for analysis of a single analyte in a sample.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to explain the principles of the invention and its practical applications, they thereby enable others skilled in the art to utilize the invention and various embodiments with various modifications as are suited to the particular use contemplated. It is intended that the following claims and their equivalents define the scope of the invention.

1. A method for processing a sample, comprising:
illuminating a sample in a chamber with at least one light source, the sample comprising one or more marker particles each specific to a feature of interest;
generating an image of the sample with an imager array;
identifying one or more features of interest in the sample based at least in part on a darkness shift of the one or more marker particles depicted in the image.

2. The method of claim 1, wherein generating the image comprises generating a shadow image of the sample.

3. The method of claim 1, wherein the sample comprises a first marker particle having a first form and a second marker particle having a second form different from the first form.

4. The method of claim 3, wherein the first form has a different size than the second form.

5. The method of claim 3, wherein the first form has a different shape than the second form.

6. The method of claim 3, wherein the first marker particle has a different material than the second marker particle.

7. The method of claim 1, wherein the first marker particle is specific to a first feature of interest and the second marker particle is specific to a second feature of interest, and wherein the method comprises distinguishing between the first feature of interest and the second feature of interest in the sample by determining whether an imaged object depicted in the image is the first marker particle or the second marker particle.

8. The method of claim 1, wherein the feature of interest is an analyte.

9. The method of claim 1, wherein the feature of interest is a cell, cell surface protein, cell lysate, or marker in a cell lysate.

10. (canceled)

11. The method of claim 1, further comprising inducing the darkness shift through an enzyme-mediated reaction that results in a darkening substance.

12. (canceled)

13. A method for processing a sample, comprising:
illuminating a sample in a chamber with at least one light source, the sample comprising one or more marker particles each specific to an analyte;
generating an image of the sample with an imager array;
identifying one or more analytes in the sample based at least in part on the sizes of the one or more marker particles depicted in the image.

14. The method of claim 13, wherein generating the image comprises generating a shadow image of the sample.

15. The method of claim 13, wherein the sample comprises a first marker having a first size and a second marker having a second size different from the first size.

16. The method of claim 15, wherein the first marker is specific to a first analyte and the second marker is specific to a second analyte, and wherein the method comprises distinguishing between the first analyte and the second analyte in the sample by determining whether an imaged object depicted in the image is the first marker or the second marker.

17. The method of claim 16, wherein determining whether an imaged object is the first marker or the second marker comprises measuring the size of the imaged object and comparing the measured object size to at least one of the first size and the second size.

18. The method of claim 15, wherein the sample comprises a marker construct comprising the first marker combined with the second marker, and wherein one or both of the first marker and the second marker is specific to the first analyte.

19. The method of claim 18, wherein identifying the first analyte in the sample comprises determining whether an imaged object depicted in the image comprises the first marker and the second marker.

20. The method of claim 15, wherein the sample comprises a plurality of first markers of the first size configured to agglutinate in the presence of the first analyte, and a plurality of second markers of the second size configured to agglutinate in the presence of a second analyte, wherein the plurality of first markers is separate from the plurality of second markers.

21-24. (canceled)

25. The method of claim 13, wherein the sample comprises at least one POD.

26-27. (canceled)

28. A method of preparing one or more samples for processing, comprising:
combining the one or more samples with marker particles, wherein the one or more samples comprise a first analyte, a second analyte, and a third analyte;
wherein the marker particles comprise:
a plurality of first markers each having a first size;
a plurality of second markers each having a second size different from the first size; and
a plurality of marker constructs comprising at least one first marker combined with at least one second marker.

29-49. (canceled)
